(19) United States
(12) Patent Application Publication
(10) Pub. No.: US 2015/0127687 A1
(43) Pub. Date: May 7, 2015

(54) SYSTEM AND METHODS FOR CREATING AND MODIFYING A HIERARCHIAL DATA STRUCTURE

(71) Applicant: Roger Graves, North Gower (CA)

(72) Inventor: Roger Graves, North Gower (CA)

(21) Appl. No.: 14/531,525

(22) Filed: Nov. 3, 2014

Related U.S. Application Data
(60) Provisional application No. 61/899,426, filed on Nov. 4, 2013.

(51) Int. Cl. G06F 17/30

(52) U.S. Cl. CPC G06F 17/30589; G06F 17/30289
USPC 707/803

(57) ABSTRACT

A computer device, system and method are provided which enable a hierarchical computer data structure to be created and modified as a cooperative activity involving a plurality of individuals or workgroups using independent computers and data structures without being connected by, or continuously connected by, a linking infrastructure such as a computer network. Sections of the data structure and supporting data may be exported as subfiles, modified, and later imported back into the hierarchical data structure. Controls are provided to manage the growth of the data structure and the modification or addition of common data. Changes to the data structure also may be disseminated to exported subfiles.

### CROSS-REFERENCE TO RELATED APPLICATION

This application claims priority to U.S. Provisional Application No. 61/899,426, filed on Nov. 4, 2013, the disclosure of which is incorporated herein by reference in its entirety.

### TECHNICAL FIELD

This invention relates to the field of programming general purpose digital computers. More particularly, this invention relates to the ability of a group of participants to cooperate in a common project using independent computers in the absence of a linking infrastructure such as a computer network.

### BACKGROUND

When several individuals combine their efforts to undertake a task using general purpose digital computers, such as the creation of a large report or the creation of costing data for a large project, the work is usually split into a number of sections. Each section is worked upon by one or more individuals, and these sections are then recombined into the final product.

Splitting up and subsequently recombining sections of work which are not tightly integrated together is not a major problem. For example, a document such as a report can be divided into several chapters, each chapter can be written by a different individual, and the entire document can then be assembled using a word processing program. Difficulties may arise when the work is based upon a tightly integrated structure and/or includes a common database or other data structure to which individuals have the ability to make additions and changes.

Data management of the latter kind is normally implemented via a central database to which the workgroup members have access via a computer network. However, circumstances can arise in which such networks are either unavailable, such as individuals working in remote locations, or are not advisable for security reasons. In some cases, a central or master file containing the structural and other common data is maintained, and all changes to this data outside this master file are forbidden. Sections of the work which are split off, known herein as subfiles, would then contain a copy of this database, but would not be able to make any changes to it. However, this would introduce an unwanted rigidity into the system with constant requests from subfile owners for database changes and additions, and the necessity of downloading them in a timely fashion from the master file to the subfiles.

### SUMMARY

Embodiments of the present disclosure provide a computer system and method which enable work to be performed as a cooperative activity involving a plurality of individuals or workgroups using independent computers and data structures not necessarily connected by, or continuously connected by, a linking infrastructure such as a computer network. The present disclosure enables the successive delegation of work in a one-to-many hierarchically-structured work product, and its subsequent re-integration into a single entity through the creation and control of structural data and common data associated with the data structure and delegated portions of the data structure. Once an initial work product structure is defined in a master file, a portion of the work product structure may be exported as an independent file known as a subfile and transferred to a second computer for further work and updates. The system and methods describe herein also control the import of the updated subfile back into the master file.

According to an aspect of the present disclosure there is provided a method of maintaining and updating a data structure in a computing device. The method includes creating a master file containing a data structure table representing a hierarchical data structure consisting of one or more nodes, each node being related to at least one other node by a parent-child relationship. Each node has a unique system number and a record in the data structure table, the record having fields containing the unique system numbers of the node, its parent, and any child nodes. The method includes exporting any selected node from the master file. The selected node is exported from the master file by generating a subfile for the selected node and any lower level nodes descending from that node wherein each node is assigned a subfile system number. The subfile contains node-specific data, a subfile structure table having a record for each node in the subfile, the record having fields for the subfile system numbers of the node, its parent node, and any child nodes, and a subfile lookup table having a subfile system number map of subfile system numbers and corresponding unique system numbers in the master file. Generating the subfile includes retaining a copy of the subfile lookup table in the master file. The method also includes importing a modified subfile for the previously exported node into the master file by updating records in the data structure table based on the subfile system number map and corresponding records in the subfile structure table.

According to an aspect of the present disclosure there is provided a non-transitory computer readable storage medium having stored thereon computer-readable and computer-executable instructions, which, when executed by a processor, cause a computing device to perform actions which include creating a master file containing a data structure table representing a hierarchical data structure consisting of one or more nodes, each node being related to at least one other node by a parent-child relationship. Each node has a unique system number and a record in the data structure table, the record having fields containing the unique system numbers of the node, its parent, and any child nodes. The actions include exporting any selected node from the master file. The selected node is exported from the master file by generating a subfile for the selected node and any lower level nodes descending from that node wherein each node is assigned a subfile system number. The subfile contains node-specific data, a subfile structure table having a record for each node in the subfile, the record having fields for the subfile system numbers of the node, its parent node, and any child nodes, and a subfile lookup table having a subfile system number map of subfile system numbers and corresponding unique system numbers in the master file. Generating the subfile includes retaining a copy of the subfile lookup table in the master file and The actions include importing a modified subfile for the previously exported node into the master file by updating records in the data structure table based on the subfile system number map and corresponding records in the subfile structure table.

According to an aspect of the present disclosure there is provided a computing device which includes a memory a processor; and one or more non-transitory computer readable media having computer executable instructions stored thereon for maintaining and updating a data structure in the memory. The instructions, when executed by the processor, cause the computing device to perform actions including creating a master file containing a data structure table representing a hierarchical data structure consisting of one or more nodes, each node being related to at least one other node by a parent-child relationship. Each node has a unique system number and a record in the data structure table, the record having fields containing the unique system numbers of the node, its parent, and any child nodes. The actions include exporting any selected node from the master file. The selected node is exported from the master file by generating a subfile for the selected node and any lower level nodes descending from that node wherein each node is assigned a subfile system number. The subfile contains node-specific data, a subfile structure table having a record for each node in the subfile, the record having fields for the subfile system numbers of the node, its parent node, and any child nodes, and a subfile lookup table having a subfile system number map of subfile system numbers and corresponding unique system numbers in the master file. Generating the subfile includes retaining a copy of the subfile lookup table in the master file and The actions include importing a modified subfile for the previously exported node into the master file by updating records in the data structure table based on the subfile system number map and corresponding records in the subfile structure table.

According to an aspect of the present disclosure there is provided a computer readable storage medium in a computing device, the medium having stored thereon computer-readable and computer-executable instructions, which, when executed by a processor, cause the computing device to perform actions comprising: creating a master file containing a data structure table representing a hierarchical data structure consisting of two or more nodes, each node having a unique system number; receiving a request to export a selected node of the data structure; determining whether the selected node of the data structure may be exported and, if so, generating a subfile from the selected node, the subfile having data relating to the selected node together with a subfile lookup table; receiving a request to import the subfile; determining whether the subfile is compatible with the master file, and if so, integrating the subfile into the data structure of the master file.

According to further aspects of the present disclosure, receiving a request to export a selected node of the data structure comprises receiving a request to export a selected node from a subfile, thereby creating a lower-level subfile, and so on to as many subfiles levels as requested. In some embodiments, generating a subfile further comprises first determining whether a pre-existing subfile has been generated for an ancestor node in a level of the data structure above the selected node, and if so, denying the request to export the selected node. In some embodiments of the present disclosure, generating a subfile further comprises first determining whether a pre-existing subfile has been generated for a descendant node in a level of the data structure below the selected node, and if so, denying the request to export the selected node.

According to further aspects of the present disclosure, generating a subfile comprises copying common data from the master file to the subfile. In some embodiments, constraints may be assigned to subfile common data. In other embodiments, no constraints are assigned and common data may be modified in a subfile.

According to further aspects of the present disclosure, generating a subfile comprises generating the subfile lookup table and storing the subfile lookup table in the parent file and in the subfile. In some embodiments, the subfile lookup table comprises a subfile number and a system number map. In some embodiments, the subfile number comprises a series of numbers corresponding to the serial number of the subfile with respect to its parent file and the serial number of that parent to its parent, and so on up to the originating master file. In some embodiments, the system number map comprises a record of subfile node system numbers and the corresponding node system numbers in the parent file. In some embodiments the subfile lookup table may include one or more common data maps which record the correspondence of common data fields in subfile and parent file.

According to further aspects of the present disclosure determining whether the subfile is compatible with the parent file further comprises identifying potential conflicts between a common data item in a subfile and a corresponding item in a parent node, prompting a user to resolve the potential conflicts, and receiving a request to integrate one of the data item from the subfile or the data item from the parent node.

According to further aspects of the present disclosure, there is provided a computer system including two or more computing devices as described above which are configured to exchange data over a communications network. A first computing device includes computer-executable instructions which further direct the first computing device to transmit a subfile over the communications network to a second computing device. According to further aspects of the present disclosure, the second computing device is configured to receive, add and modify data in a subfile, which may include receiving and adding nodes to the data structure. In some aspects, the second computing device is configured to transmit a modified subfile over the communications network to the first computing device. In some aspects, the subfile is transferred from the first computing device to the second computing device and/or from the second computing device to the first computing device using a computer readable storage media.

### BRIEF DESCRIPTION OF THE DRAWINGS

The following detailed description when read in connection with the accompanying drawings describes embodiments of the invention.

FIG. 1 illustrates an example hierarchical node structure;

FIG. 2 is a view of a hierarchical subfile structure;

FIGS. 3A and 3B illustrate hierarchical data structures and modified data structures; FIGS. 3C and 3D illustrate a computer system and a computer according to embodiments of the present disclosure;

FIG. 4 is a diagram of structure table records;

FIG. 5 illustrates a system number map example;

FIGS. 6A and 6B illustrate a system number map example;

FIG. 7 illustrates a common data map example;

FIG. 8 illustrates transition pairs;

FIG. 9 illustrates an example of subfile creation;

FIG. 10 illustrates a flowchart for subfile export process;

FIG. 11 illustrates an example of hierarchical subfile creation limits;

FIG. 12 illustrates an example of node removal during subfile creation;

FIG. 13 illustrates a flowchart for a subfile fleshing out process;

FIG. 14 illustrates an example of multi-level subfiles

FIG. 15 illustrates a flowchart for subfile importation process;

FIG. 16 illustrates a flowchart for subfile importability checking;

FIG. 17 illustrates a flowchart for a common data change acceptability checking;

FIG. 18 illustrates a flowchart for reconciling compatible differences in common data;

FIG. 19 illustrates a flowchart for determining compatibility of new common data fields;

FIG. 20 illustrates an example of node additions to Source file;

FIG. 21 illustrates an example of node deletion in the Source file;

FIG. 22 illustrates an example of node deletion in the target file;

FIG. 23 illustrates an example of automatic node movements on import;

FIG. 24 illustrates an example integration of imported nodes;

FIG. 25 illustrates an example of prior importation of a node;

FIG. 26 illustrates an example of prior importation correction;

FIG. 27 illustrates a flowchart for checking for prior importation of nodes;

FIG. 28 illustrates an example of prior importation of a common data field, and FIG. 28A illustrates a flowchart for checking for prior importation of common data fields;

FIG. 29 illustrates an example of data dissemination;

FIG. 30 illustrates a flowchart for data dissemination process;

FIG. 31 illustrates an example of common data flow across several subfile levels;

FIG. 32 illustrates an example embodiment of node definition and selection processes;

FIG. 33 illustrates a sample risk matrix;

FIG. 34 illustrates a sample cost allocation;

FIGS. 35A-D illustrate example subfile export, fleshing out and import actions;

FIG. 36 illustrates a sample control form for a new master file;

FIG. 37 illustrates a sample notice regarding a subfile finalization;

FIG. 38 illustrates an example common data modification;

FIG. 39 illustrates a sample price data comparison form;

FIG. 40 illustrates a sample cost allocation comparison form;

FIG. 41 illustrates a sample data dissemination form; and

FIG. 42 illustrates a sample notice regarding subfile modification.

While the invention will be described in conjunction with the illustrated embodiments, it will be understood that it is not intended to limit the invention to such embodiments. On the contrary, it is intended to cover all alternatives, modifications and equivalents as may be included within the scope of the invention as defined by this specification as a whole, including the appended claims.

### DETAILED DESCRIPTION OF THE INVENTION

Definitions

The following definitions are referred to in the present disclosure.

Children and Descendants: A subfile exported from a parent file is known as the child of that parent. If more than one subfile level exists, there can be children of children, and so on, all of which are known collectively as descendants of that parent.

Common Data: Data which is not specific to any particular node, but which can be used in any node.

Exporting: The process whereby sections of the work to be performed by the workgroup can be separated out from the master file for completion by individual members of the group.

Fatal Error: An incompatibility between source file and target file which cannot be resolved, resulting in premature termination of the import process.

File: An assemblage of computer-compatible data containing all the information necessary for an individual member of a workgroup to perform their workgroup-related activities.

File Owner: The individual or workgroup that has been given control of a particular file.

Fleshing Out: The process of entering data into a subfile. The data so entered may be any or all of structural data, node-specific data, or common data.

Importing: The process whereby a subfile is recombined back into its original parent or ancestral file.

Master File: In some embodiments, a single file, known as the master file, represents the entire set of work to be performed by the workgroup, albeit initially in very brief outline. All data from all sources within the exported and updated portions of the work structure will ultimately be imported back into the master file.

Node: The work to be performed is assumed be capable of being broken down into a hierarchical structure. A node represents an identifiable element of this structure. When first created, a node is an empty container which may later have data entered into it (see Fleshing Out).

Node Number: Each location in the hierarchical structure has an address, such as 1.2.3, which is known as the node number of that location. Each node record has an associated node number, but this can change as nodes are moved around in the structure. In some embodiments, other forms of node numbering may be used, such as a fixed-digit system, e.g. 12300.

Node Record: Structure Table data consists of a series of records, one for each node, known as node records.

Node-Specific Data: Data which is contained by, and is specific to, a particular node in the hierarchical structure.

Orphaned Node: A node which has been created in a subfile and then imported into a parent file, and which has subsequently been deleted in the subfile so that, while it exists in the parent file, there is no longer any counterpart to it in the subfile.

Parent and Ancestors: Any file from which subfiles have been exported is known as a parent file. If more than one subfile level exists, there can be parents of parents, and so on, all of which are known collectively as ancestors of that subfile.

Parent Node: The node in the parent file from which a subfile has been exported, and which will be the point of attachment for the subfile when it is imported back into the parent file.

Sibling Group: A series of nodes which are located in the hierarchical structure such that their node numbers differ only in the last digit, such as 1.1.1, 1.1.2 and 1.1.3.

Source File: The file that is being imported during an import process.

Structural Data: Data which specifies how each node of the hierarchical structure relates to other nodes in the structure.

Structure Table: Structural data is maintained in each file within a Structure Table.

Subfile: A subfile is an independent file which results from the export process. It contains a part of the data structure of the parent file from which it has been exported, plus all necessary supporting data. Lower-level subfiles can be exported from any subfile, and so on indefinitely.

Subfile Levels: A subfile which has been exported from a master file is known as a level 1 subfile. A subfile exported from a level 1 subfile will be a level 2 subfile, and so on. A master file can be described as the level 0 file.

Subfile Lookup Table (Subfile LUT): A collection of data used to control the importation of a subfile.

System Number: Each node record within a Structure table is assigned a unique number, known as its system number. Once assigned, system numbers never change within any given Structure Table.

Target File: The file into which the source file is being imported.

Top-Level Node: The node at the top of the hierarchical structure in any file. In the master file this will be node 0, in any subfile it will be a copy of the parent node from which the subfile was exported.

Workgroup: When an activity is undertaken which involves the efforts of more than one person, that group of people is known as a workgroup for the time that they are involved in that activity.

Embodiments of the present disclosure enable work to be performed as a cooperative activity involving a plurality of individuals or workgroups using independent computers not necessarily connected by a linking infrastructure such as a computer network. The present disclosure enables the successive delegation of work in a hierarchically-structured work product, and its subsequent re-integration into a single entity. The primary processes involved are the initial definition of the work in broad outline, in a form known as a master file, the subsequent delegation of sections of the work to other individuals or workgroups by exporting these sections as independent files, and the subsequent importation of these files back into the master file when work on them has been completed.

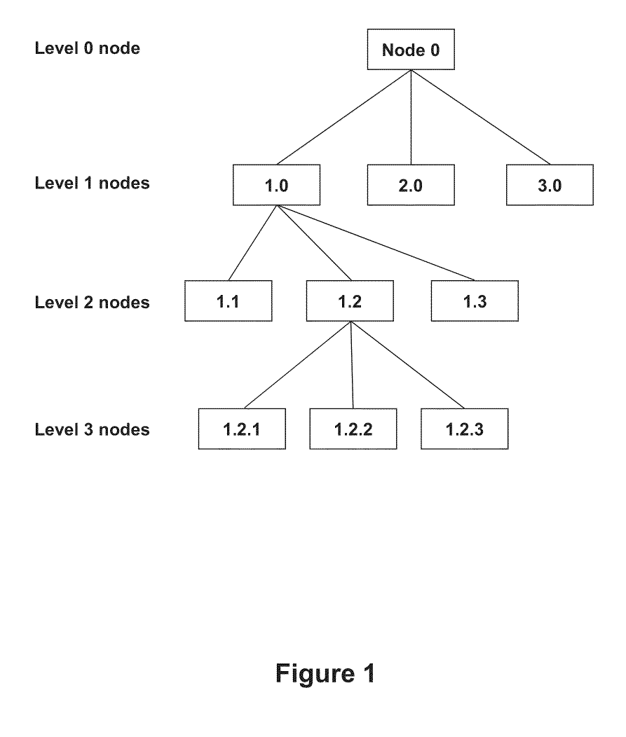

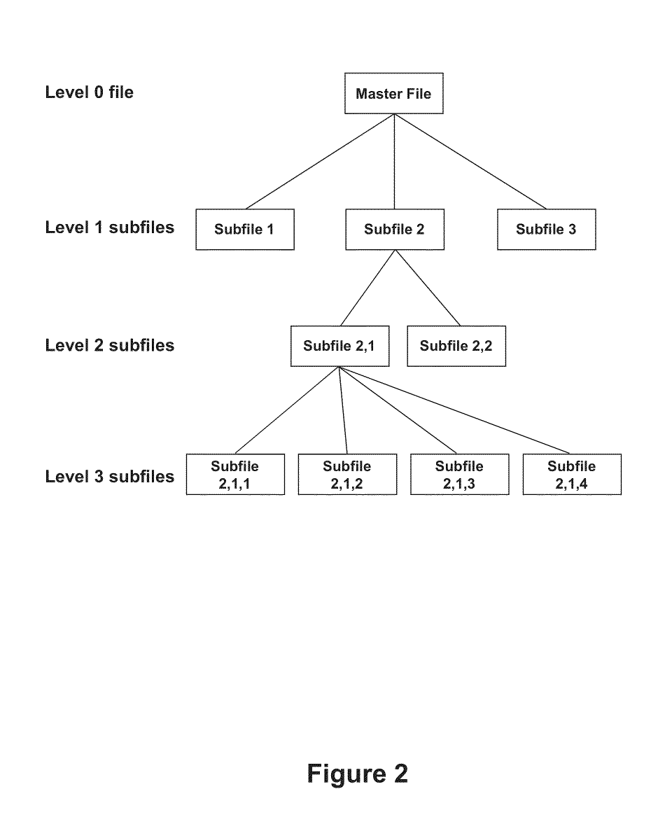

In order for the delegation process to operate, the work to be performed should be capable of being defined in terms of a one-to-many hierarchical data structure. In one embodiment, the data structure is defined as a series of nodes arranged in a one-to-many hierarchical structure, such as that illustrated in FIG. 1. In one embodiment, any arbitrary section of the work can be represented by an individual node in the data structure. Delegation of a portion of the work is effected by separating out a section of this structure consisting of a single node, plus any descendants that node may already have. Such a separated section, together with all the supporting data, will comprise an independent file known as a subfile. Since the delegation process can be repeated within any subfile, the subfiles themselves form another hierarchical structure, as illustrated in FIG. 2. According to embodiments described herein, any node may be exported, or “hived off” into an independent subfile for use, for example, by another person or organization. As part of the export process, a set of parameters is created, known as a subfile lookup table, or subfile LUT, containing the information used to reintegrate the subfile back into its parent file.

Parts of any subfile so created may in turn be exported, so the whole process can be regarded as one of successive delegation of parts of the work product.

In some embodiments, nodes may be viewed as data containers. Additional nodes may be added to a subfile and the section of the hierarchical data structure that the subfile represents. Other data may be entered in the exported or newly created nodes. Subfiles may also inherit common data from their parent files, and may modify that data or add additional items of common data. For example, in one embodiment wherein the work product comprises a costing projection, an example of data entered into a node may be the number of labor hours required to complete a task, while an item of common data may be the hourly rate for that labor.

Once a subfile has been “fleshed out”, it is then passed back to its parent file and imported back into it. Importation involves, among other things, the integration of the subfile node structure back into its parent's node structure, and the reconciliation and integration of any common data items which have been added or modified in the subfile.

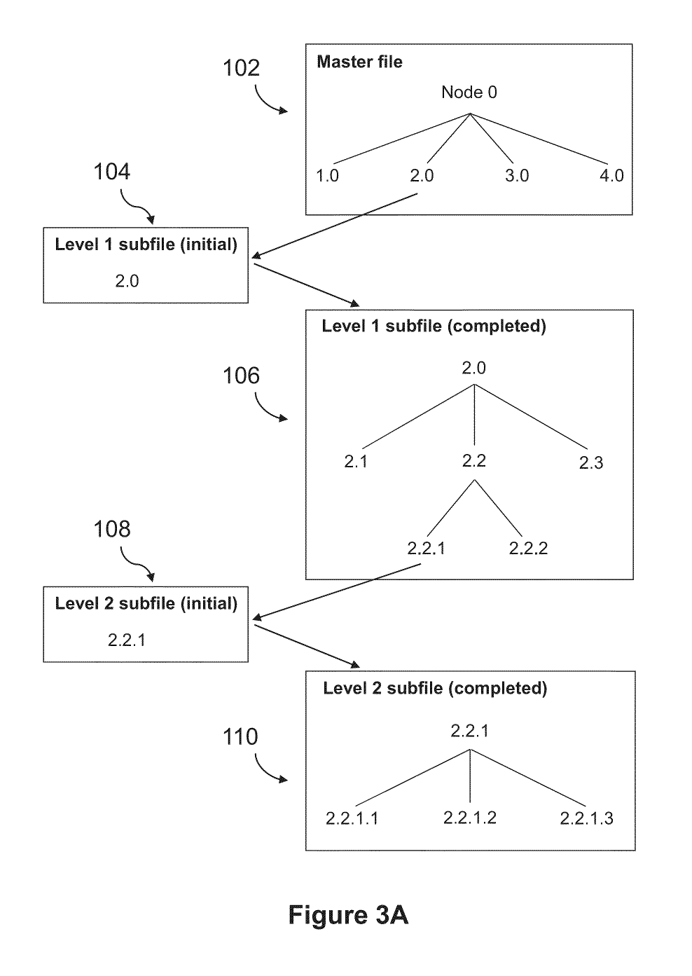

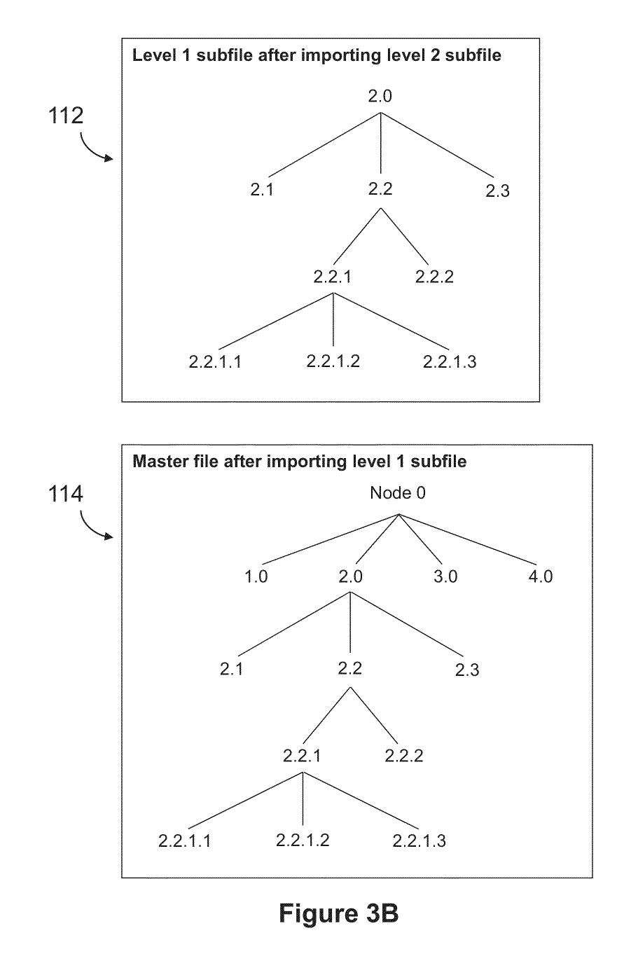

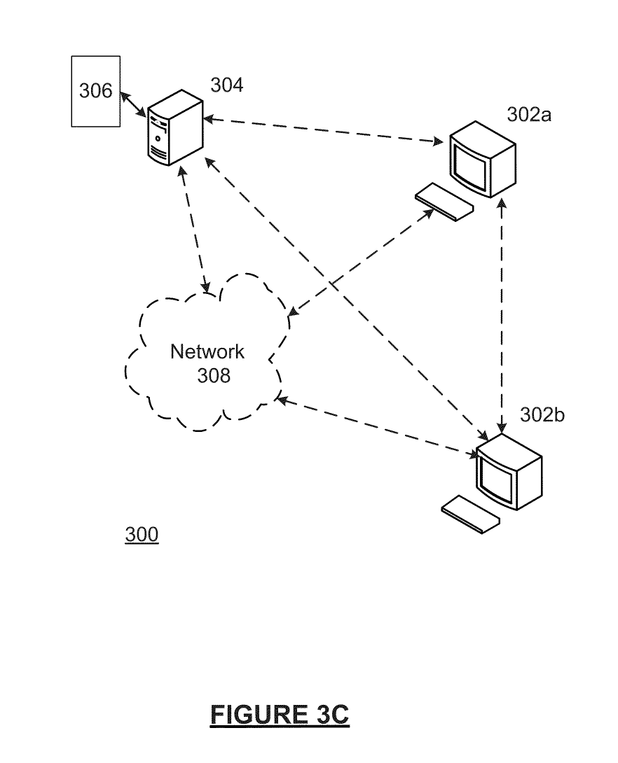

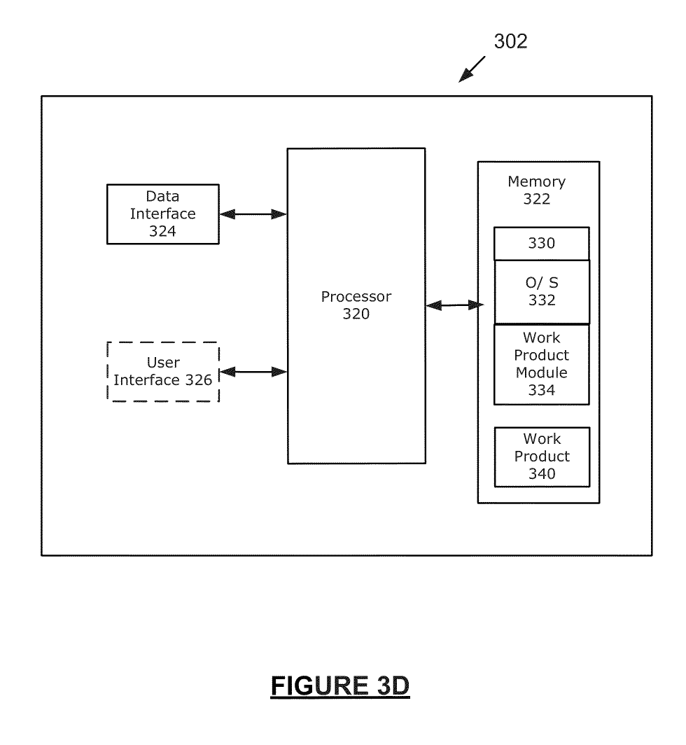

FIGS. 3A and 3B illustrate a sample hierarchical work structure during these processes. FIG. 3A shows a top-level file, or master file 102, of which node 2.0 is exported as a subfile 104. Additional nodes may be added to node 2.0 within subfile 104 as shown at 106. Further, one of the added nodes may be exported as a level 2 subfile 108. Additional nodes may be added to node 2.2.1 within subfile 108 as shown at 110.

The level 2 subfile may be imported back into its parent, as shown in FIG. 3B at 112. Subsequently, the level 1 subfile is then imported back into the master file as shown at 114.

Any data added into any of the nodes in the level 2 subfile will be imported with those nodes into the level 1 subfile, and from there into the master file. Similarly, any common data added to the level 2 subfile will be imported into the level 1 subfile and from there into the master file. This constitutes a mechanism whereby portions of a work product may be delegated to other individuals or workgroups. The export and subsequent import of portions of the work product may be performed by one or more computers linked through a communications network. The one or more computers may be linked through other means which may or may not provide a continuous or constant link between the computers.

In one embodiment, the hierarchical data structure or work product is created and stored by a computer system 300 as shown in FIG. 3C. In one embodiment, the computer system 300 may comprise one or more computers 302a, 302b which may be a personal or desktop computer, notebook, handheld computer or mobile device. In other embodiments, the computer system 300 may comprise one or more servers 304 and database 306, which are also illustrated in FIG. 3C for reference. One or more computers 302a, 302b may be connected to each other through a communications network 308 to perform the export, import and other operations described herein. The communications network 308 may comprise a wireless or wired network. In some embodiments, the computer 302a may link with other computers 302b to perform the export and import and other operations described herein through other means, such as by a temporary wired or wireless connection between the two computers. In other embodiments, portions of the work product may be transferred between computers 302a, 302b through other means such as by the physical transport of a file on a computer readable media, including but not limited to, a hard drive, disc, or memory stick (not shown).

A computer 302 configured to carry out the embodiments of the present disclosure is illustrated in FIG. 3D. The computer 302 includes at least one processor 320, a memory 322 and a data interface 324 for exchanging data, as well as a power source (not shown). In one embodiment, the data interface 324 comprises a communications interface for sending and receiving data through the network 308. In other embodiments, the data interface 324 is configured to support a wired or wireless connection to another device. In other embodiments, the data interface 324 is configured to accept a memory device such as a memory stick, and to read from and write to the memory device. In some embodiments, the computer system includes a user interface 326 which is configured to receive data, such as information or commands from a user, and which is also configured to provide output to a user. The user interface 326 may comprise additional inputs and/or outputs including but not limited to one or more of a display, keyboard, audible alert, and touchscreen. In other embodiments, the user interface may be provided in a separate device which connects to or communicates with the computer 302 through the data interface 324.

The processor 320 interacts with the memory 322 and with the data interface 324 to support the functions and communications described herein. In some embodiments, the memory 322 comprises one or more of a flash memory, random access memory (RAM), read only memory (ROM) or hard disk. The processor 320 executes one or more functional modules 330 stored in the memory 322. The modules comprise an operating system software 332 and other applications to provide the functions and operations described herein including a work product module 334. It will be appreciated the operations implemented by the modules 330 may be realized by a plurality of modules or as parts of other modules. In some embodiments, the modules 330 are in the form of computer readable instructions which are executed by the processor 320.

In one embodiment, the memory 322 also stores the work product 340. The work product 340 may comprise the entire data structure created according to the present disclosure or the work product 340 may comprise a portion of the data structure that has been exported and transferred to the computer 302. The processor 320 and work product module 334 are configured to perform export and import processes, create and update lookup tables and maps, and identify and resolve conflicts between portions of the data structure as described herein. The processor 320 and work product module 334 also may be configured to generate alerts to a user and receive user selections or commands. Alerts may be generated, for example, to inform users of changes or if user actions are required, such as to resolve conflicts during an import process. In some embodiments, the processor 320 and work product module 334 are configured to send messages to a user assigned to a particular subfile, such as messages to move or delete a node in the subfile. The message may be sent through the network 308 or stored and forwarded to the user if the user is working offline from the network 308.

In some embodiments, a particular computer 302a and/or user may be designated to store and control the master file. In other embodiments, the computer 302a currently storing the master file may be designated to control the master file. In some embodiments, the data provided to a subfile and constraints on the modifications which may be made to such data are controlled during the export of a subfile. Similarly, changes which are imported back into the master file are controlled through the import process as described below. In other embodiments, user permissions may be assigned to control access to data, subfiles, master files and permitted actions associated with these files and data.

Two areas addressed by the present disclosure are the organization and control of structural data, i.e. the data which describes and controls how one part of the work product relates to and combines with other parts of the work product, and the control of common data, i.e. non-structural data which may nevertheless be used in more than one part of the work product.

In one embodiment, development of a work product 340 involves six processes:

1. Master file establishment: creation of a master file, or level 0 file, representing the totality of the work to be performed, albeit initially in very abbreviated form;

2. Exporting: splitting the work into discrete sections by creating independent files (subfiles) which represent sections of the work, and optionally continuing the work-splitting process by creating lower level subfiles from those subfiles, to as great a depth as required;

3. Fleshing out: entering data into individual files, which activity may be performed in isolation by separate individuals or workgroups;

4. Importing: recombining data into a coherent whole by importing fleshed-out subfiles back into their parent files;

5. Data dissemination: optional dissemination of common data between subfiles by downloading an updated set of common data to individual subfiles when they are imported back into their parent file, so that they will contain the entire set of common data currently residing in the parent file; and

6. Subfile updating: transferring an updated version of the subfile back to its owner, if any changes have occurred which need to be registered in the subfile.

The term parent file as used here refers to any file from which subfiles have been exported. This includes the master file and any subfile at any level from which lower-level subfiles have been exported.

Data Structures

This subsection describes an example organization of a database for hosting the six processes described above.

In one embodiment, the data within any one file, whether master file or subfile, may be broken down into the following categories: 1. Structural data; 2. Node-specific data; 3. Common data; 4. System parameters; and 5. Subfile lookup tables (subfile LUTs).

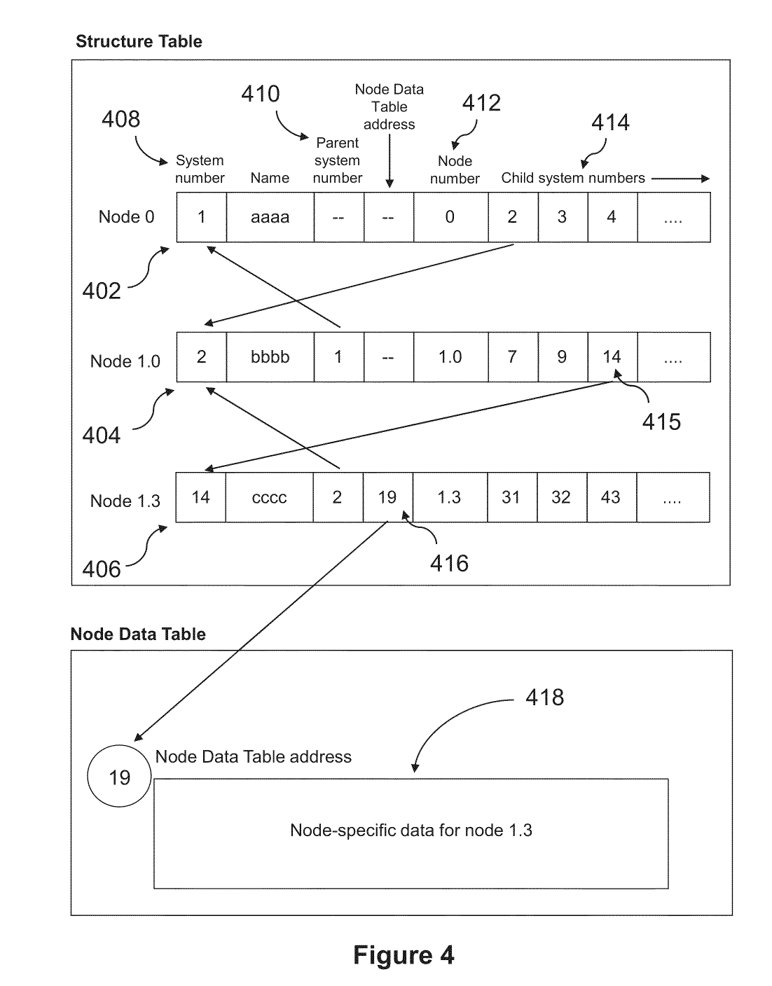

Structural Data. Structural data defines and controls the database hierarchical structure. In any one file, structural data is contained within a Structure Table. Each record within the Structure Table represents a single node of the database hierarchical structure. FIG. 4 shows the Structure Table records 402, 404, 406 for nodes 0, 1.0, and 1.3 respectively of FIG. 1.

System Numbers. Each Structure Table record is assigned a unique system number 408. Each Structure Table record contains a link 410 to the Structure Table record of the parent of the node that it represents, and links 414 to the Structure Table records of any children of the node that it represents may have. In one embodiment, as shown, such links are specified in terms of system numbers. While subsequent additions, movements and deletions of nodes within the hierarchical structure can alter the position of nodes within the structure, system numbers, once assigned, do not change within a Structure Table.

Node Numbers. Each Structure Table record 402, 404, 406 may include a node number 412 which describes the position of that node within the structure, e.g. 1.2.3. If node numbers are included, the node numbers are updated by the work product module 334 if the position of the node in the structure changes due to the addition of nodes and fleshing out of subfiles. In another embodiment, node numbers may also be determined by the work product module 334 based on the Structure Table records, using the position of an item in its parent's child list to define the last component of the corresponding node number. For example, as illustrated Structure Table Record 406 in FIG. 4, node 1.3, having system number 14, is referenced in the third position 415 in its parent's list of child system numbers 414. The node number of any record can therefore be determined by tracing its parent links all the way up to the topmost record in the structure.

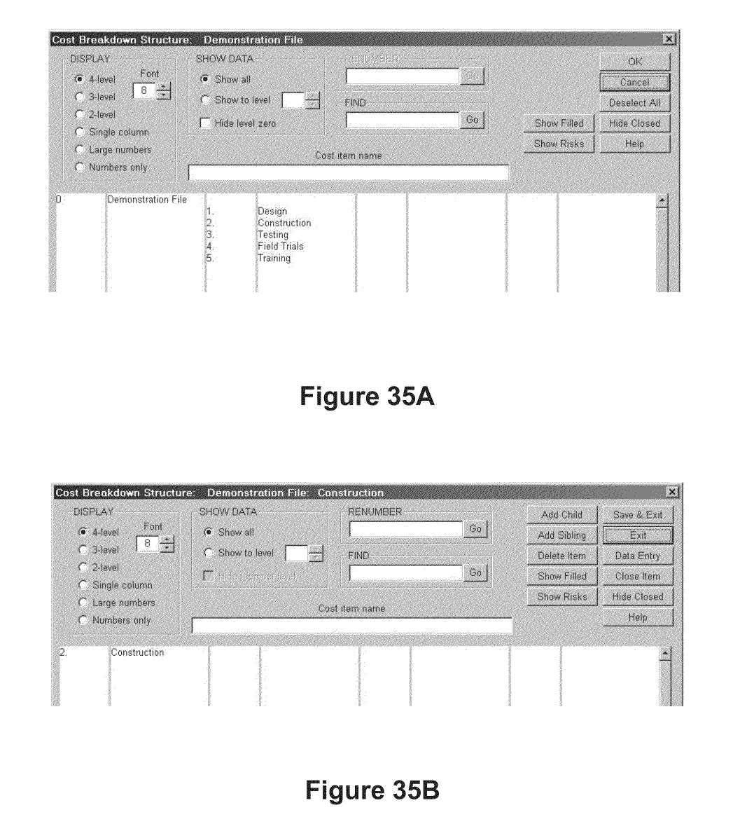

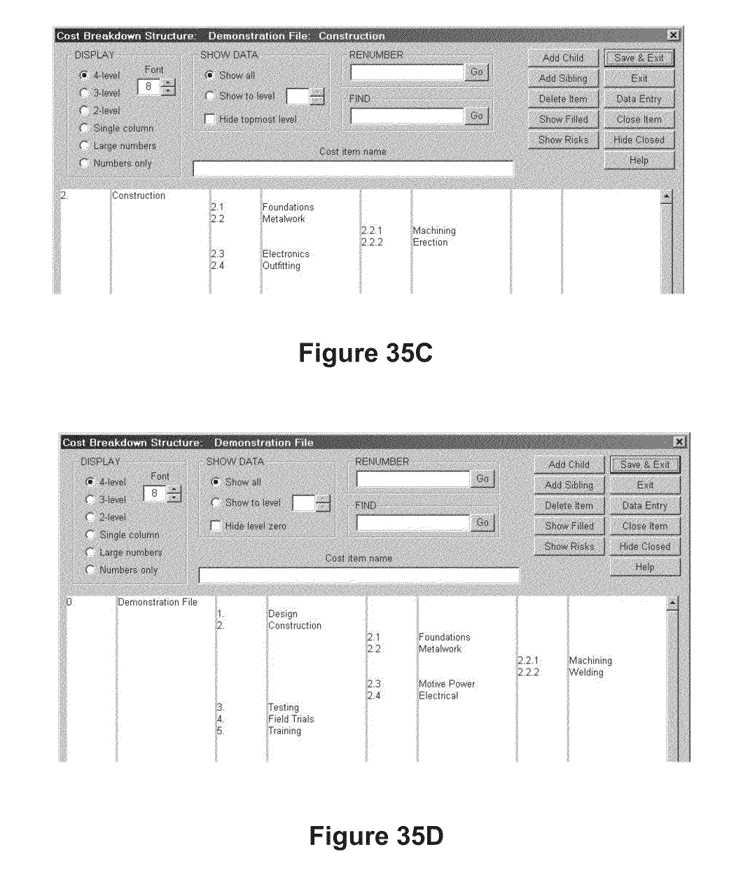

In one embodiment, the system 300 may be configured by a user or operator to include node numbers 412. Node numbers 412 may be included, for example, where less frequent structural changes are expected such that the updating of node numbers 412 by the work product module 334 occurs less frequently. In applications where the extraction by the work product module 334 of node numbers from node records for any purpose, such as displaying to the operator or including in a report, will occur more frequently than structural changes which trigger the work product module 334 to determine corresponding node number changes, the explicit inclusion of node numbers in node records would improve operational efficiency since the work product module 334 is not required to determine the node numbers 412 for each instance of use. The node numbers 412 which are included in the system 300 or which are determined by the work product module 334 may be displayed to the operator, such as in FIGS. 35A-35D, described below.

Data Table Address. Each Structure Table node record contains a Node Data Table Address 416 of the start of the entries for that node in the Node Data Table 418 (see below). In some cases, this part of the record may be a blank address if no data has yet been entered.

Adding New Nodes. When a master file is first created, a zero-level node record, representing the topmost point of the hierarchical structure, is created as part of the data structure. New nodes can be created by adding children to the zero-level node and then by adding siblings or children to these new nodes and their descendants (siblings are related nodes on the same level, e.g. 1.1 and 1.2, while children are related nodes one generation apart, e.g. 1.2.1 is a child of 1.2). In response to a request to add a new node, the work product module 334 adds a new record to the Structure Table to represent that node, and adds a link to it in its parent's record. In one embodiment, new nodes are always added at the end of their sibling group, if one exists, so that additions do not disturb existing node numbers.

Deleting Nodes. In response to a request to delete a node, all its descendants are deleted with it. In one embodiment, a node is deleted by the work product module 334 deleting the records for that node and its descendants from the Structure Table, and erasing the link to that node in its parent's record. Any associated data in the Node Data Table (see below) is also deleted. In one embodiment, where node numbers are included explicitly in each node record and where gaps are not permitted in node numbering, the nodes below the deleted node in a sibling sequence and all their descendants have their node numbers edited to remove the gap caused by the deletion. For example, if the sibling group 1.1, 1.2 and 1.3 exists and 1.2 is deleted, node 1.3 would be renumbered as 1.2, and node 1.3.1, if it exists, would be renumbered as 1.2.1.

Moving Nodes. In response to a request to move a node in the structure from one location to another, all its descendants are moved with it. The link in its original parent is erased and a new link is inserted into its new parent. The work product module 334 does not change the system numbers or their places in the Structure Table records, nor does the location of any associated data in the Node Data Table change. In one embodiment, the work product module 334 changes the node numbers of all nodes affected by the move both in the original location and in the new location, so that all sibling groups have node numbers whose last digits form a continuous series beginning at 1 without any gaps or duplications.

Node-Specific Data. A single node can be regarded as a container for data. Data associated with individual nodes is known as node-specific data and is defined in a separate table or set of tables or other data structure, depending on the quantity and type of data to be stored, known collectively as the Node Data Table. In one embodiment, no direct links are permitted between the data associated with different nodes, so that changing the data associated with any one node will not directly affect the data associated with any other node. Apart from these restrictions, any type of node-specific data may be accepted and may be arranged in any fashion.

Common Data. Common data consists of non-structural data which can apply to more than one node. For example, in a project costing application, while an item of node-specific data might consist of the number of labor hours required to complete a particular task, the hourly rate for that labor would be an item of common data since it could be applicable to more than one node. Common data is defined and maintained in a table or set of tables or other data structure, depending on the quantity and type of data to be stored, known collectively as the Common Data Table.

Since the Common Data Table is copied as a single entity from parent file to subfile when the subfile is exported, no restrictions are placed on the format of the data that may be accepted as common data as long as it is possible to add, modify and delete individual items of data within it.

System Parameters. System parameters may include a number of parameters as outlined below as well as other parameters used to keep track of data within the database, the general nature of and necessity for which will be apparent to anyone skilled in the art. Included in the system parameters according to one embodiment are:

Master File Recognition Code. The master file is assigned a recognition code, such as a long, randomly generated character string. This code is copied to all subfiles derived directly or indirectly from that master file, thereby enabling them to be recognized as having been derived from that master file.

The probability of any two master files having the same recognition code should be made small. Since computer-generated codes are necessarily created by a determinate process and can therefore be only pseudo-random, the possibility exists that two master files, if created in identical circumstances, could both have the same recognition code. In one embodiment, this possibility is reduced to an acceptably low level by delaying the creation of the recognition code until the first subfile is created. The seed value for the code generation routine is then derived from an algorithm whose inputs are the date and time on which the master file was created (which are stored as system parameters), and the date and time on which the first subfile is created.

Level Number. Level numbers define the generation to which a subfile belongs. A subfile which is an immediate child of the master file is known as a level 1 subfile. Its immediate children are known as level 2 subfiles, and so on. The master file is the level 0 file.

Subfile Serial Number. Each subfile exported from a parent file is given a serial number based on the order in which it was exported from that parent file. In one embodiment, serial numbers always start from 1 within any parent file.

Subfile Count. A count is maintained in each file of the number of subfiles which have been exported from that file so that a correct serial number can be assigned to each new subfile.

Top-level Node Number. The top-level node number is the node number at the top of the hierarchical data structure in the subfile. For example, if node 2.1 is exported as a subfile from a master file, the top-level node number for that subfile will be 2.1. Any nodes subsequently created within that subfile will be limited to descendants of node 2.1. In one embodiment, top-level node numbers are defined for all subfiles but not for master files since there are no restrictions on the node numbers which may be created within a master file.

Subfile Lookup Tables (Subfile LUTs). A subfile lookup table, or subfile LUT, is a collection of data that is used during the importation of a subfile into its parent or ancestor. A unique subfile LUT is created and stored in memory 322 for every subfile for every import transition, such as a subfile-to-parent, or a subfile-to-ancestor transition. In one embodiment, each subfile LUT will contain a subfile number and a system number map as described below.

Subfile Number. In one embodiment, each subfile is assigned a serial number relative to its parent. Since the parent, if it is also a subfile, will have its own serial number relative to its parent, any subfile at any level is uniquely characterized by a chain of serial numbers which details its ancestry back to the master file. Thus, for example, a level 3 subfile might be denoted as (2,1,4), indicating that it is the 4th subfile of the 1st subfile of the 2nd subfile of the master file. (Commas are used as separators to avoid confusion with node numbers.) This series of numbers is collectively known as the subfile number and is stored as part of the subfile LUT, where it identifies the subfile to which that LUT refers.

System Number Map. The system number map provides a record of the correspondence or mapping between subfile system numbers and parent system numbers after a subfile is imported back into its parent. When a subfile is imported back into its parent, each node in the subfile is assigned a system number in the parent. If a node existed when the subfile was first exported it will already have a corresponding system number in the parent, but if the node was created after the subfile was exported it will not have a counterpart in the parent file and must be assigned a new system number. New system numbers may not be predicted or assigned in advance of importation, because the parent may have multiple subfiles, all of which may have an unknown number of new nodes which are assigned new system numbers upon import.

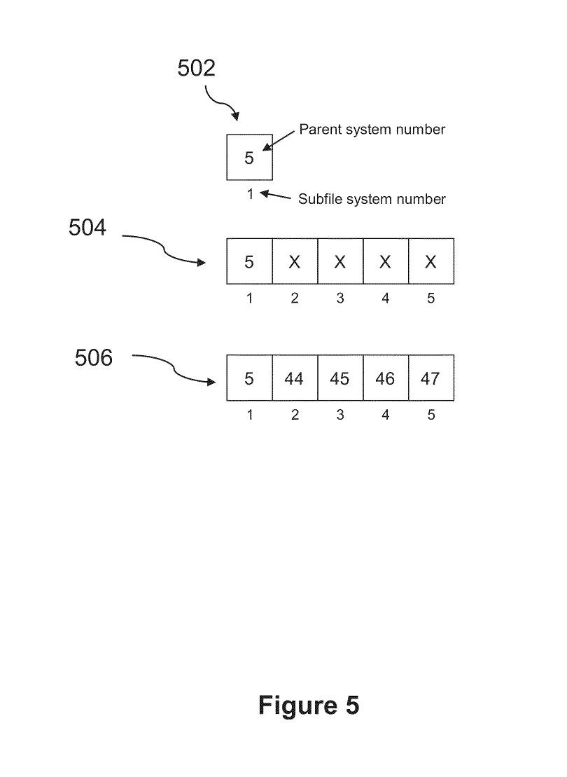

An example of this is shown in FIG. 5. A subfile was originally exported from a node with parent system number 5 in the parent file. This node will locally be assigned subfile system number 1 in the subfile as shown in the original system number map 502, after export of the subfile. The subfile thus originally consisted of node 5 of the parent file. If four new nodes are then created in the subfile after it is exported, the new nodes would be assigned local system numbers 2 through 5 as shown at the system number map 504, prior to importation. The parent system numbers are shown as “X” in 504 since these numbers have not yet been assigned or referenced in the parent. On import back into the parent file, the new nodes will be assigned the first four available system numbers in the parent file, for example in this case system numbers 44 through 47 as shown at the system number map 506, after importation.

This difference in system numbers between subfile and parent will be of minor consequence if the subfile is imported only once. However, if the subfile is updated and imported a second or further time a record of the assigned parent system numbers is used so that nodes in the subfile are correctly identified with their assigned counterparts in the parent file. This record is known as the system number map, and in one embodiment, it is created and stored as part of the subfile LUT.

If a subfile is imported into a more distant ancestor for update purposes, in one embodiment the correspondence between subfile and ancestor system numbers is established by the work product module 334. In one embodiment, this is performed by tracing system numbers up the chain of system number maps for each single-level import between the subfile and its ancestor. In one embodiment, the system requires that all the single-level imports between subfile and ancestor should have already occurred so that updated system number maps are available at each level. Thus for example, if a level 2 subfile is to be imported into the level 0 master file, the corresponding 2/1 import (i.e. level 2 subfile imported into its level 1 parent) and 1/0 import must both have previously occurred.

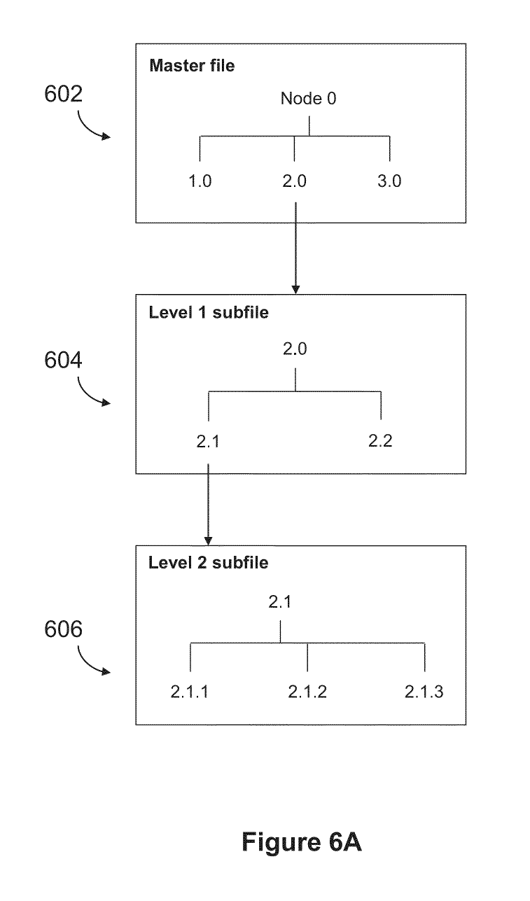

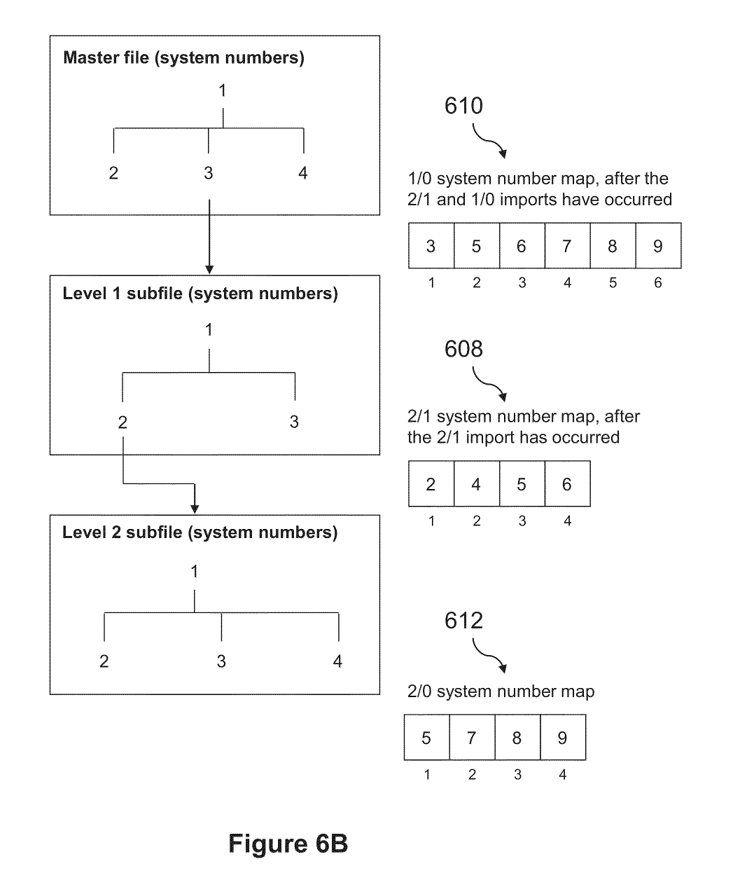

Creation of subfile-to-ancestor system number maps is illustrated in FIGS. 6A and 6B. For ease of reference, import transitions are described herein as, for example, “2/1” referring to the import of a level 2 subfile into a level 1 subfile. FIG. 6A shows a simple 2-level subfile sequence, from master file 602 to level 1 subfile 604 to level 2 subfile 606. FIG. 6B shows the same subfile sequence but with node numbers replaced by system numbers. Assuming for the sake of simplicity that no other subfiles exist, the 2/1 system number map 608 is shown after the 2/1 import has occurred, noting the additional system numbers (4-6) which have been added to the level 1 subfile to accommodate the new nodes added to the level 2 subfile. The 1/0 system number map 610 is then shown subsequent to both the 2/1 import and the 1/0 import, again noting the new system numbers (5-9) added to accommodate the new nodes added in both the level 1 and level 2 subfiles. Finally, at the foot of the diagram, the 2/0 system number map 612 synthesized by tracing values upwards from the 2/1 map to the 1/0 map is shown. As described above, the system number maps are stored as part of the subfile LUT created or updated for every import transition.

Common Data Maps. In one embodiment, common data items are assigned field numbers. Field numbers are analogous to system numbers in the structural data, and may be subject to similar requirements for mapping and tracing upon import.

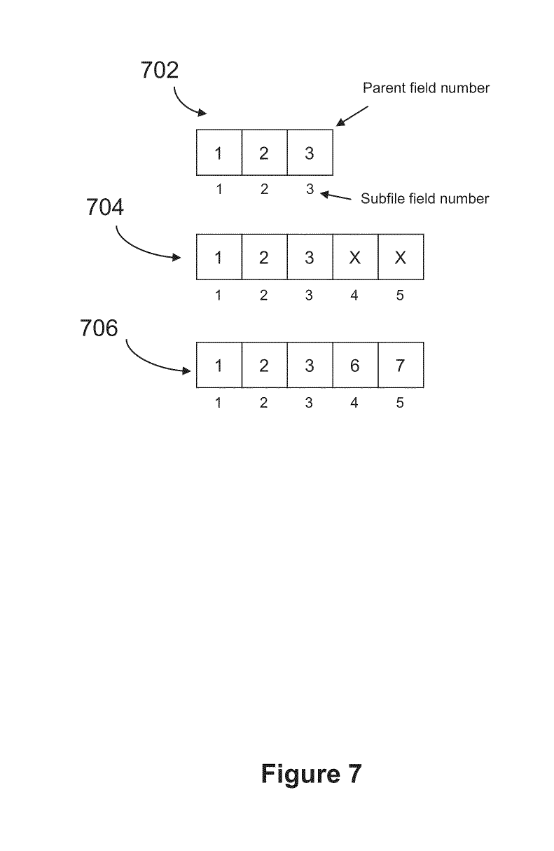

When a subfile is first exported from its parent file, its common data will have the same field numbers as its parent, because the subfile inherits the entire Common Data Table of the parent without change. If new common data items are created in a subfile, these are assigned their own field numbers in the subfile by the work product module 334. When the subfile is imported back into its parent file, these new field numbers are translated to parent field numbers. However, the field numbers used in the subfile may already be occupied in the parent by imports from other subfiles or by new items created directly in the parent file, so these new subfile data items may have to be assigned different field numbers in the parent. An example of this is shown in FIG. 7. Three common data fields were inherited from the master file when the subfile was exported, with field numbers 1, 2 and 3 in both parent and subfile, as shown in the original data map 702. Two new fields of the same type are then created in the subfile and are assigned field numbers 4 and 5 in that subfile as shown in the data map 704 prior to importation. The parent field numbers are shown as an “X” since these fields have not yet been referenced in the parent. However, if field numbers 4 and 5 are already occupied in the master file by imports from other subfiles, the two new fields will be assigned the next available numbers, in this case 6 and 7, upon import into the master file as shown in the data map 706 after importation.

This difference in field numbers will be of minor consequence if the subfile is imported only once. However, if the subfile is imported a second or further time for update purposes, a record of the new field numbers is used, so that fields in the subfile can be identified with their counterparts in the parent file.

A record of the correspondence between field numbers in the subfile and field numbers in the parent file is known as the common data map for that subfile/parent combination. In one embodiment, the work product module 334 creates a separate common data map for each distinct type of common data, such as, in one embodiment, separate common data maps for prices, currencies, tax rates and risk impacts. A set of such common data maps is maintained for every subfile and parent combination or subfile and ancestor combination. In the latter case, the correspondence between subfile and ancestor field numbers is established by tracing subfile field numbers up the chain of common data maps for each single-level import between the subfile and its ancestor, in the same manner as for system number maps.

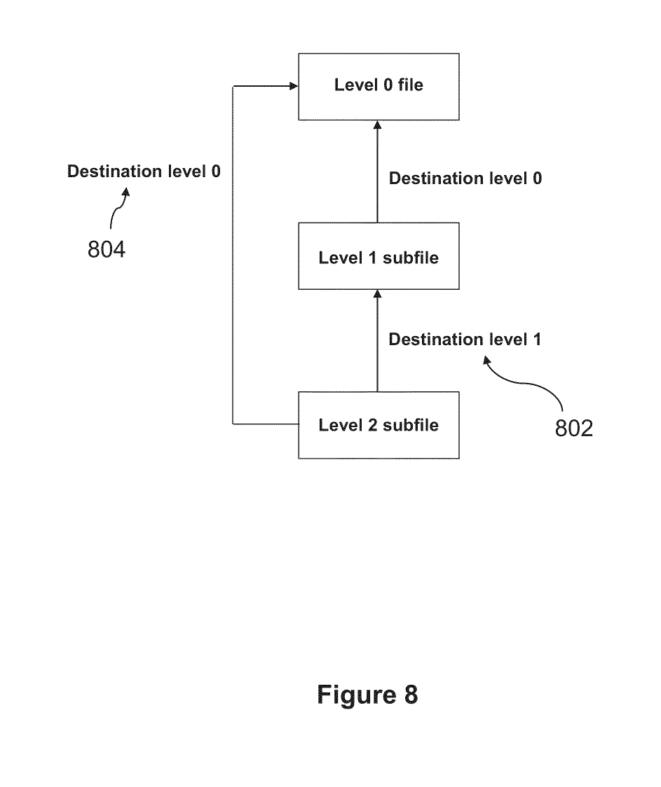

Destination Level. A subfile is normally imported into its immediate parent. However, as previously noted, it is also possible for a subfile to be imported into a more distant ancestor for update purposes. In such cases the system number map and common data maps of the subfile LUT record the correspondence between subfile and ancestor values, as described above. Since the one-to-many hierarchical structure of the subfile constellation ensures that any subfile can only have a single ancestor at any subfile level, it is only necessary to specify that level in order to identify the ancestor unambiguously. The subfile level of the ancestor to which the maps relate is known as the destination level. Thus, as shown in FIG. 8, the destination level for the importation 802 of a level 2 subfile into its level 1 parent would be 1. The destination level for the importation 804 of the same level 2 subfile into the master file would be 0. The destination level is stored as part of the subfile LUT.

Subfile LUT Contents and Locations. In one embodiment, each subfile LUT contains: (i) Date/time on which the LUT was created or last updated; (ii) Subfile number; (iii) System number map; (iv) Common data maps (one for each distinct data type), and (v) Destination level to which the maps relate.

In one embodiment, a subfile LUT is used for every subfile for every import transition. When a subfile is first created, the LUT for its importation back into its parent (single-level transition) also may be created and stored with both the subfile and its parent. The LUT is updated as appropriate during import to reflect changes that may occur to both the system number map and the common data maps, as indicated above. The updated LUTs will replace the original stored LUTs. In one embodiment, after the subfile is created, the subfile including the subfile LUT may be transferred to a second computer 302b while the parent file and corresponding subfile LUT may be maintained on a first computer 302a.

If the subfile is subsequently imported directly into an ancestor, which is described herein as a multi-level transition, a corresponding LUT may be created at that time and stored on both the subfile and its ancestor.

Database Processes

This subsection further describes example implementations of the six processes described at the top of this section.

Master File Establishment

The master file represents the totality of the work to be created, and may eventually contain the data for the completed project, as described below. Master files can be created ab initio, in which case they may contain the following data: 1. A Structure Table with a zero node record in it, i.e. a record representing the topmost node in the hierarchical structure, with node number 0; 2. A master file recognition code; 3. A level number of zero, indicating that this file is a master file; and 4. A subfile count, which is set to zero.

Alternatively, a new master file can be created from an existing master file or from an existing subfile if a similar project is to be repeated. In such cases, a copy of the old file is made, a new recognition code is inserted, the level number is set to zero, the subfile count is reset, any subfile serial number and top-level node number are deleted, and all node-specific data and subfile LUTs are deleted by the work product module 334. The Structure Table may optionally be deleted as well, except for the top-level (zero) node, or it may be retained and modified for use in the new file. All the common data in the old file is retained.

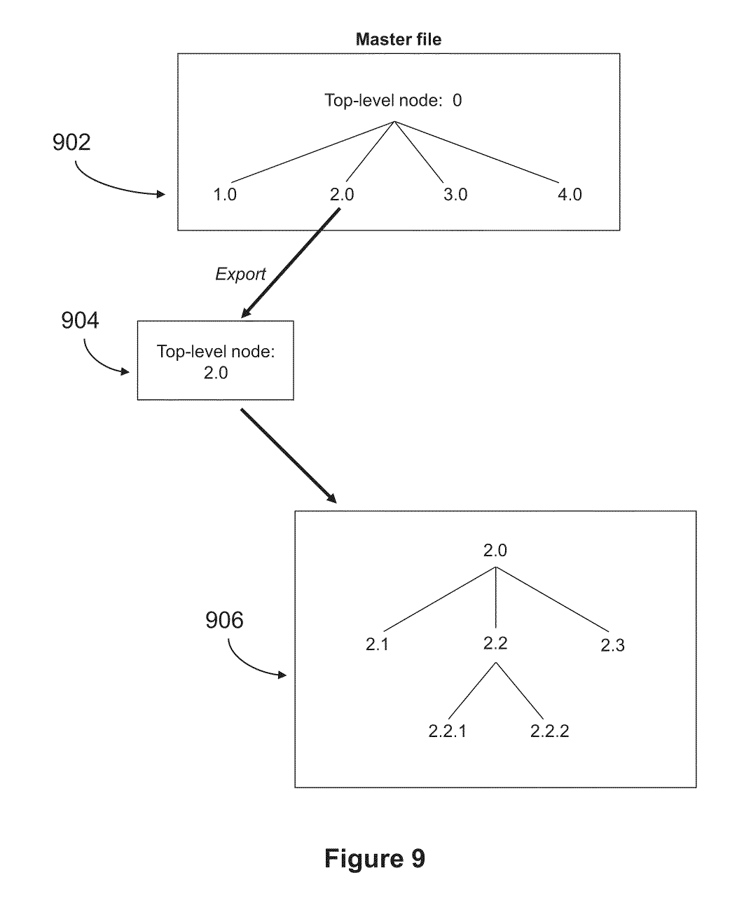

At least one descendant node of the zero-level node is added in the master file or maintained in a master file created from an existing file. Each descendant node represents a portion of the work to be performed and the contents and number of nodes may be defined by a user. A typical hierarchical structure of a new master file 902 with four descendant nodes, 1.0, 2.0, 3.0 and 4.0, is shown in FIG. 9.

Exporting

Exporting represents a method of delegating sections of the work into successively smaller parcels. For example, referring to FIG. 9 the 2.0 node of the master file 902 may be exported as a subfile 904. The subfile 904 may be transferred to another computer through a network, direct connection or through the physical transport of the subfile on a computer readable media. The creation of the subfile 904 enables the section of the work represented by that node to be transferred to another person or workgroup for further development. The recipient of this level 1 subfile is then at liberty to develop the hierarchical structure 906 descending from the 2.0 node, and delegate in turn any of the new nodes by exporting level 2 subfiles in a similar process.

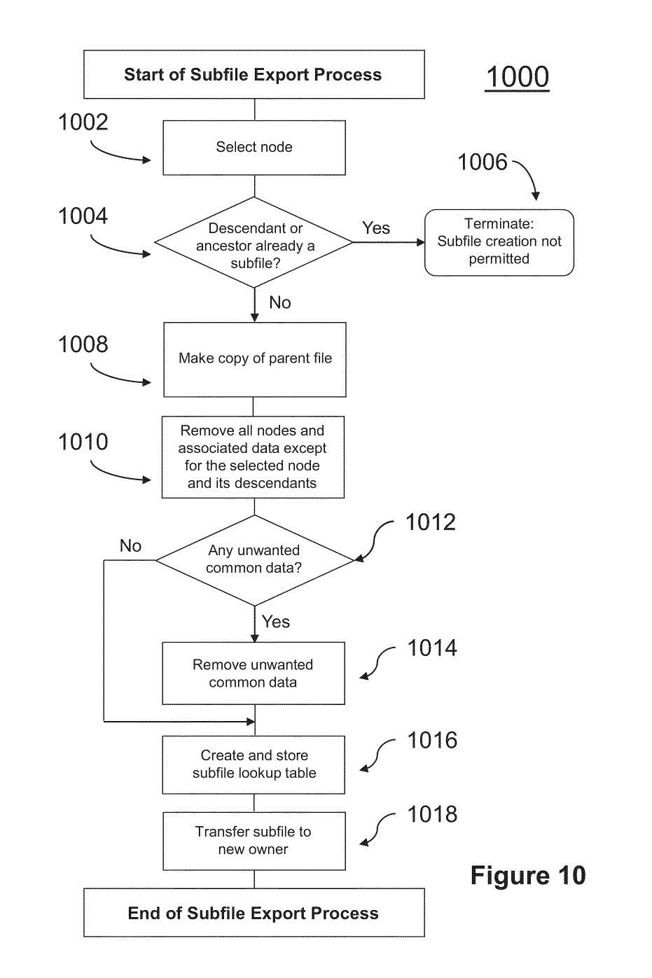

In one embodiment, the export process 1000 uses the following steps, as indicated in the flowchart in FIG. 10. The steps are summarized below and then described in further detail.

i) Node selection—selecting 1002 the node which will define the new subfile;

ii) File creation—creation 1008 of a new file representing the subfile;

iii) Node removal—removal 1010 of all nodes from the Structure Table of the new file, together with any associated Node Data Table entries, except for the selected node and its descendants;

iv) Removing unwanted common data—removal 1014 of any unwanted common data;

v) Subfile LUT creation—creation 1016 of data required for subsequent importation back into the parent; and

vi) Subfile transfer—the newly created subfile may be transferred to another computer as described above for use by an individual or workgroup who maintain control over the subfile until it is imported back to its parent or ancestor.

i) Node Selection

In one embodiment, a user initiates the export process by selecting 1002 the node in the parent file which will be the top-level node in the new subfile. Referring back to the example of FIG. 9, the selected node in the parent file is 2.0, and this becomes the top-level node for the new subfile 904.

Limitations to Node Selection

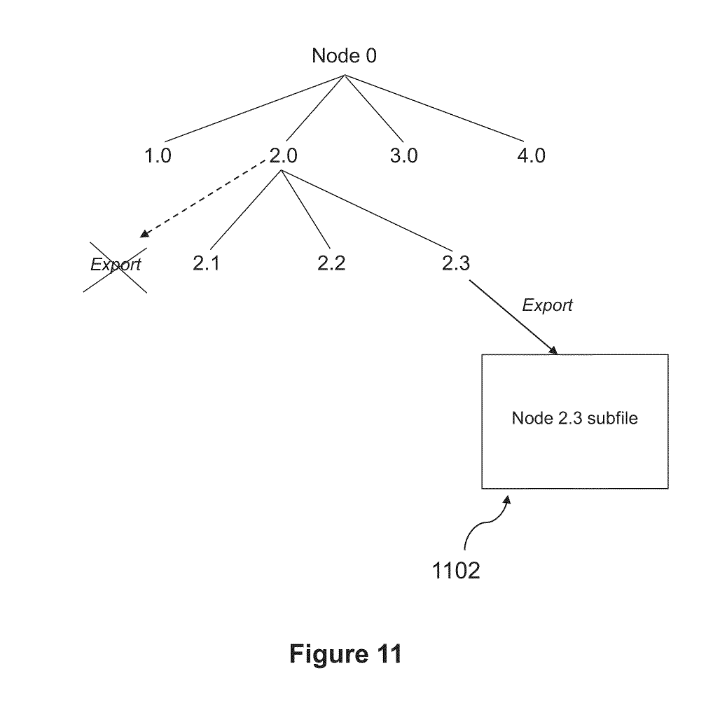

In one embodiment, the work product module 334 denies the creation of a subfile and terminates 1006 the export process if another subfile of the same parent file already exists which represents a descendant or ancestor of the selected node. Otherwise it may be possible for duplicate versions of some nodes to be independently created in different subfiles and which could cause confusion if imported back into the parent file. For example, as shown in FIG. 11, assume that node 2.3 has been created in the master file, and is exported as a subfile 1102. If node 2.0 is then permitted to be exported as another subfile, it would be possible for another version of node 2.3 and its descendents to be created independently in this new subfile, which would result in confusion if both subfiles were imported back into the work product. Similarly, if node 2.0 has been exported from the master file, then any of its descendants such as node 2.3 may not subsequently be exported as independent subfiles from the master file, although they can of course be exported as lower-level subfiles from the 2.0 subfile.

The existence of a subfile based on an ancestor or a descendant of the selected node is determined by the work product module 334 from the data in the subfile LUTs associated with the parent file.

Subfile Deletion

In some embodiments, since the creation of a subfile may be inhibited if an ancestor or descendant of the desired node has already been exported as a subfile, a subfile deletion capability is provided to deal with such cases. To continue the example above, if node 2.3 had been exported as a subfile but it was then decided by a user that node 2.0 was required to be exported as a subfile, it would be necessary for the user to delete subfile 2.3 before the 2.0 subfile could be created.

Subfile deletion is accomplished by the work product module 334 deleting from the parent file all reference to that subfile, including references to any descendants of that subfile that may already have been imported into the parent file. While it may not be physically possible to delete the actual subfile itself, since it may be located on a different computer, deletion of all reference to it in the parent will prevent it from being imported into the parent, and thus it ceases to be a subfile of that parent.

ii) File Creation

In one embodiment, in response to a request to create a new subfile, the work product module 334 creates the new subfile by making a copy of the parent file under a new name.

iii) Node Removal

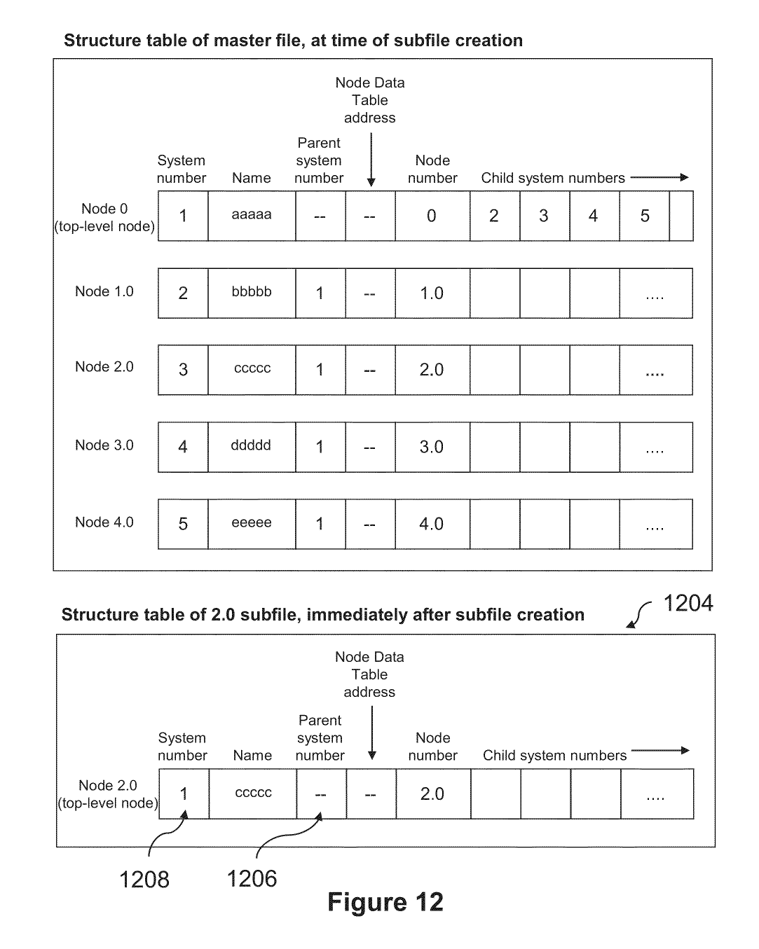

Starting from the copy of the parent file, the work product module 334 removes 1010 all node records in the Structure Table except for the records and associated data for the selected node and any descendants it may have. FIG. 12 shows the Structure Table for the master file 902 of FIG. 9. The selected node 2.0 in this table then becomes the top-level node within the Structure Table 1204 of the new subfile, shown in FIG. 12 immediately after creation. The link to its parent is deleted 1206 since it has no parent within the subfile. In some embodiments, for operational efficiency, all remaining Structure Table records in the new subfile may be assigned 1208 new, consecutive system numbers beginning at 1, and all links to parents and children are rewritten in terms of these numbers. All Node Data Table records in the new subfile are similarly deleted, save for any that are associated with the selected node and its descendants. Again, for operational efficiency, the Node Data Table is then rewritten to remove any gaps caused by deleting portions of it, and the Node Data Table addresses in the Structure Table records are updated accordingly.

iv) Removing Unwanted Common Data

In one embodiment, the entire Common Data Table of the parent file may be inherited by the new subfile so that the new file contains a copy of all the common data in the parent file. However, this common data may contain one or more fields or field types which are not required in the subfile, or sensitive information which the owner of a parent file does not wish to be made available to the subfile owner. In one embodiment, a user may be prompted to indicate whether any unnecessary or unwanted common data exists 1012. If so, the owner of the parent file may selectively identify any unwanted field types within the common data, or any unwanted individual fields within a particular field type, all of which are then removed 1014 by the work product module 334 during the subfile creation process.

Removed Fields

In one embodiment, entire common data field types that were removed from the subfile (see Removing Unwanted Common Data, above) may be recorded as empty common data maps, i.e. data maps consisting of a single value such as Null. When the subfile is subsequently imported back into its parent and any common data items in the parent file that are not present in the subfile are downloaded into the subfile (see Data Dissemination, below), this enables the removed field types to be recognized by the work product module 344 and therefore prevented from being downloaded.

In one embodiment, individual fields that were removed from a particular field type within the subfile (see Removing Unwanted Common Data, above) may be recorded in the common data map for that field type as negative values. When the subfile is subsequently imported back into its parent and any common data items in the parent file that are not present in the subfile are downloaded into the subfile (see Data Dissemination, below), this enables the removed items to be recognized by the work product module 334 and therefore prevented from being downloaded. Moreover, if there is a limited storage capacity for some field types (see Compatibility of New Common Data Fields with Target File, below), the work product module 334 uses the existence of these removed fields to prevent an excessive number of such fields being created in the subfile, thereby forestalling overflow when the subfile is imported back into its parent.

v) Subfile LUT Creation

A subfile LUT for the subsequent importation of the subfile back into its parent is created 1016 when the subfile is first exported from its parent. This subfile LUT, whose structure and content are described above, is stored in association with both the subfile and its parent file.

vi) Subfile Transfer

A newly created subfile may be transferred 1018 to an individual or workgroup by any means, such as via a physical storage medium or an e-mail attachment. Thus, a computer network or continuing connection to a computer network is not required for the transfer of subfiles to other users. Subfiles may also be transferred via a computer network including wired or wireless networks.

Fleshing Out

In one embodiment, the fleshing out process consists of entering or modifying data in individual subfiles, which activity may be performed in isolation by separate individuals or workgroups.

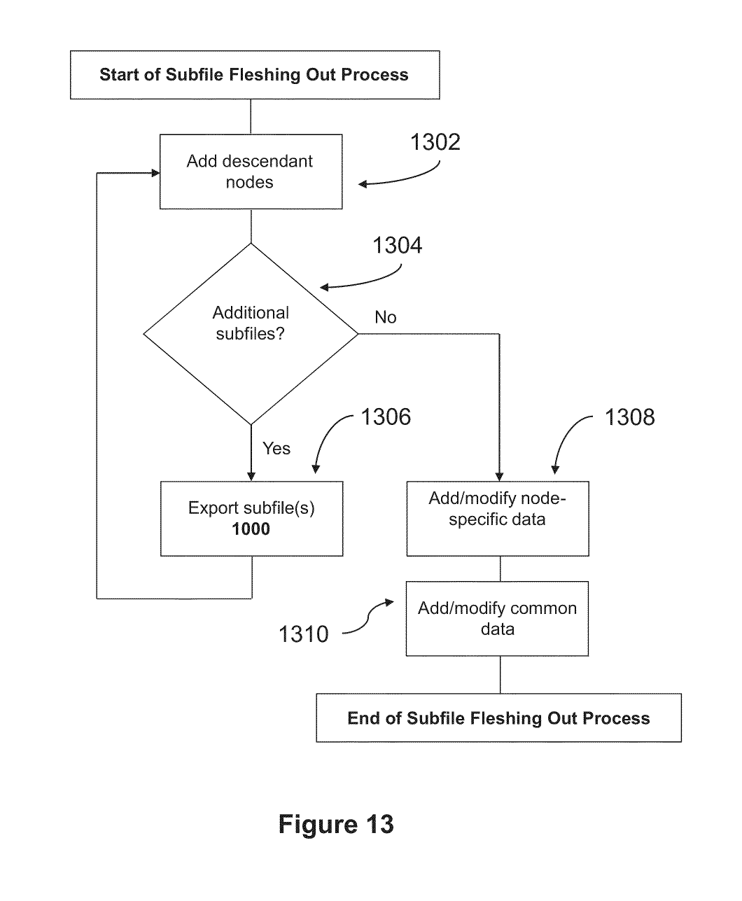

In one embodiment, the fleshing out process involves the following steps, as indicated in the flowchart in FIG. 13. The steps are summarized below and then described in further detail.

i) Adding descendant nodes—enlarging the structure of the subfile by adding 1302 descendant nodes to it;

ii) Exporting lower-level subfiles—further subdividing the work into independent sections for fleshing out by other individuals or workgroups by adding 1304 and exporting 1306 lower-level subfiles;

iii) Node-specific data changes—adding or modifying node-specific data 1308 in the subfile;

iv) Common data changes—adding or modifying common data 1310 in the subfile.

Adding Descendant Nodes

In one embodiment, subfile owners are at liberty to add 1302 as many descendant nodes to their subfiles as they wish, but the work product module 334 does not permit the addition of parallel nodes. A subfile therefore does not interfere with the structure of its parent file by permitting additions or changes outside the top-level node which is at the head of that subfile. For example, if the 2.0 node in the master file is exported as a subfile, the subfile owner is permitted to add descendant nodes such as 2.1, 2.2, etc but is not permitted to add parallel nodes such as 3.0.

Exporting Lower-Level Subfiles

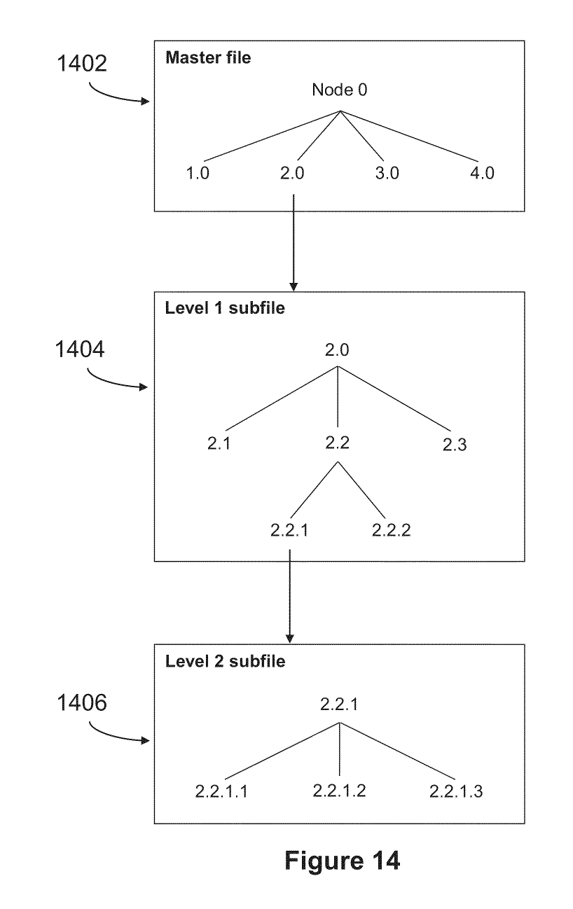

In one embodiment, subfile owners are permitted to create (i.e. export) lower-level subfiles from their own subfile. An example of lower-level subfile creation is shown in FIG. 14. The master file 1402 exports a level 1 subfile 1404 from the 2.0 node. The owner of this subfile headed by node 2.0 may expand this by adding descendants and may then export any of these descendants as a level 2 subfile 1406. This new subfile file may then be passed to a new owner, who will then be at liberty to add descendant nodes, populate them with data, and export any of them as level 3 subfiles, and so on to as many subfile levels as are required. All conditions and restrictions on subfile creation and on structural, node-specific and common data which apply to the master file and its level 1 subfiles also apply to subfiles at all lower levels.

Node-Specific Data Changes

In one embodiment, master file and subfile owners are permitted to add or modify node-specific data 1308 in any or all nodes of their files. However, in one embodiment if a subfile has previously been exported from a particular node and an attempt is made to insert or modify data directly into that node in the parent file, or one of the descendants of that node in the parent file, a warning will be issued to the user by the work product module 334 or such modification may be denied, because this could result in data being independently entered into the same node by two or more separate individuals. In one embodiment, such warnings may be overridden to allow flexibility in the system but the issued warning is such as to deprecate such forms of data entry.

Common Data Changes

Subfile owners are at liberty to add new common data fields and/or to modify existing common data fields 1310 received from their parent files.

Restrictions on Deleting Common Data

In one embodiment, the deletion of common data fields inherited from their parents is not permitted for a subfile. This restriction may be provided to guard against the possibility of a field being deleted and then replaced with an identical field at a later date, which would result in the parent file having two fields with identical functions when the subfile is imported back into its parent. An exception to this prohibition may be made when the subfile is first created, to allow for removal of unwanted data fields (see Removing Unwanted Common data, above).

Restrictions on Changing Common Data

In one embodiment, the work product module 334 does not permit the modification in a subfile of common data fields inherited from its parent. In one embodiment, work product module 334 is configured to permit some modifications to inherited common data fields and deny any modifications that would cause the data in the subfile to be interpreted incorrectly when imported into the parent file or an ancestor file. Such modifications include for example, modifications to the units or formats of common data fields. For example, in a work product created for a project costing application, if an hourly labor rate were modified to be a daily rate, and data were consequently entered into the subfile in terms of days of labor, this same data would be interpreted as hours of labor when imported back into the parent file since the corresponding rate in the parent file would still be defined in terms of hours. The work product module 334 prohibits the change of the parent file rate from an hourly rate to a daily rate by the import process since the parent file may have already imported data in terms of hours from other subfiles.

In one embodiment, the same limitation on common data changes is applied at all levels up to and including the master file. However, forbidding the master file to make such changes can cause unwanted rigidity in the system, so, in some embodiments, a warning is instead issued if the master file owner attempts to make a change to any common data which could lead to data incompatibility, but the change is not forbidden.

Importing

Importing consists of the integration of data in a subfile into its parent or ancestor file. A request to import a file may be received from a user or operator when the fleshing out process has been completed or has reached a point at which the additional data in the subfile is considered by the user to be of use to the parent file owner. The import process copies all nodes in the subfile into the parent or ancestor file, together with all node-specific data, and any new or modified common data.

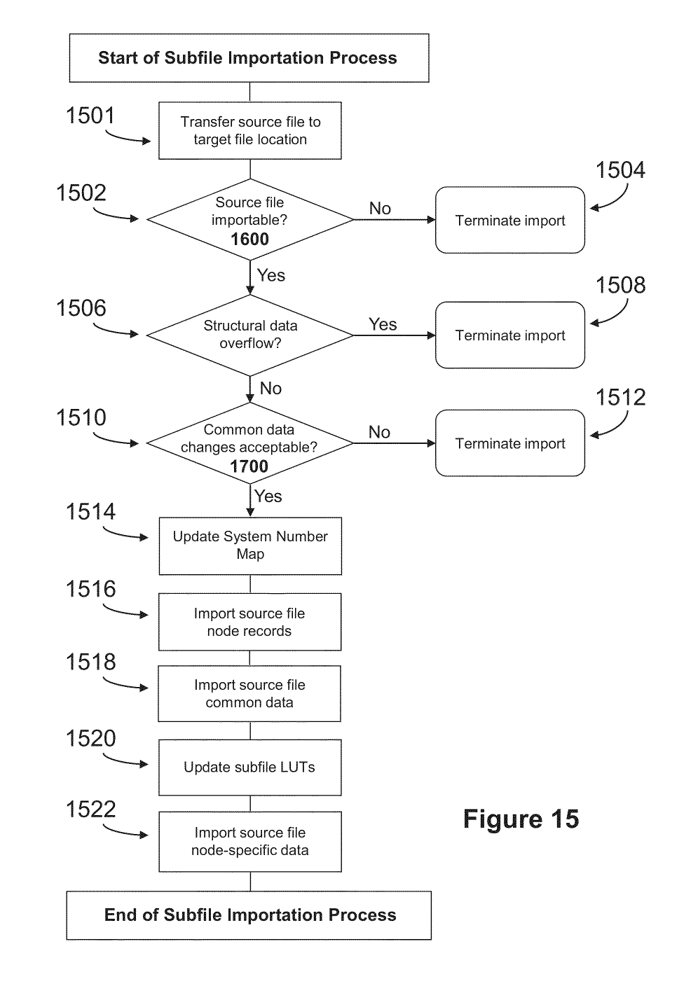

In one embodiment, the import process follows the following steps, as indicated in the flowchart in FIG. 15. The term source file refers to the file which is being imported, while the term target file refers to the file into which the source file is being imported. The steps are summarized below and then described in further detail.

i) Source file transfer—in one embodiment, the source file is first transferred 1501, by any means, to a location where it can be accessed by the target file;

ii) Checking for importability—checking that the source file is legally importable 1502 into the target file through importability checking process 1600 described below;

iii) Checking for structural data overflow—checking that the structural data to be imported will cause neither node overflow nor sibling overflow 1506;

iv) Checking for acceptability of common data changes—checking that any differences between common data in the source file and its counterparts in the target file are reconcilable, and performing reconciliation 1510;

v) Update system number map—updating the system number map 1514 to account for any changes to both source file and target file structure since the source file was created or last imported;

vi) Import source file node records—importing all node records 1516 in the source file Structure Table into the target file's Structure Table;

vii) Importing source file common data—importing the reconciled common data 1518 from the source file into the target file;

viii) Update subfile LUTs—updating the subfile LUT 1520 for this import process to accommodate any new nodes and any new common data fields, and importing any lower-level LUTs;

ix) Import source file node-specific data—importing all node-specific data records 1522 in the source file Node Data Table into the target file's Node Data Table.

Source File Transfer

A fleshed-out subfile may be transferred back to a computer or server storing its parent or ancestral file by any means, such as via a physical storage medium, a wired connection between computers, or through wired or wireless network communications, such as sending the subfile as an e-mail attachment.

Checking for Importability

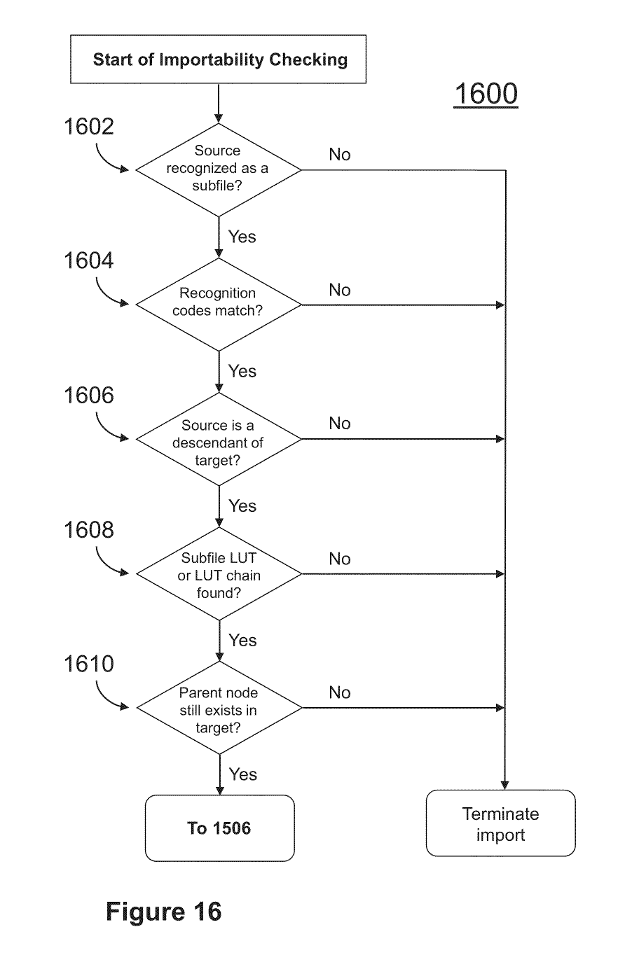

In one embodiment, the source file is checked 1502 and recognized as a bona fide subfile of the target file before any data is imported. If this is found not to be the case, the import process will be terminated 1504. This importability checking process 1600 is shown in detail in FIG. 16.

First, the source file must be recognized 1602 as a subfile. Second, the recognition codes of the source and target files are compared 1604 to ensure that both files are part of the same master file family. Third, if the target is itself a subfile, the subfile numbers of both source and target are checked 1606 to ensure that the source is a descendant of the target. For example, if the subfile number of the source file is (2,1,4) then it can be a descendant of subfiles (2,1) or (2), but not of any other subfile. It will be appreciated that this check is not necessary if the target is the master file, because all subfiles are descendants of the master file. Fourth, a search is made for the subfile LUT or LUTs which will control the import process 1608 (see Multi-Level Imports, below). Finally, if the LUT or LUTs are found and the parent node in the target file into which the source will be imported has been identified from them, a check is made to ensure that this node still exists 1610 in the target file (see Parent Node Deletion, below). If any of the above checks fail, the import process is terminated by the work product module 334.

Multi-Level Imports

The import process can proceed only if there exist maps defining relationships between source and target system numbers, and between source and target common data field numbers. If the source file is an immediate child of the target file, such maps will exist in the subfile LUT that was created when the source file was first exported. In one embodiment, parent/child relationships can be recognized because the generation levels of source and target will only differ by 1. If the source is a more distant descendant of the target, the requisite maps must be synthesized from a sequence of parent/child maps spanning the range from the current source to the current target, by tracing system numbers and field numbers up the sequence from source to target as described in the Data Structures section, above. Thus, in one embodiment in order for a multi-level import to take place, all the single-level imports spanning that range should already have occurred, so that the single-level maps for each step will exist.

The existence of such an import sequence will be signified by the presence of subfile LUTs in the target file for each of the single-level imports steps. In order that such a set of LUTs may exist in the target file, it is provided that, whenever a subfile is imported, all lower-level subfile LUTs in the source file are imported into the target file. See Updating Subfile LUTs, below.

Alternatively, if this multi-level transition been implemented previously, a LUT for this transition will have been synthesized from the single-transition LUT chain, and will be stored on both the source and target files.

Parent Node Deletion

In one embodiment, if an attempt is made by a user to delete a parent node, i.e. a node from which a subfile has previously been exported, a warning will be issued by the work product module 334 or the action may not be permitted since this would prevent that subfile from being imported back into the parent file. However, in some embodiments, such deletions are permitted to provide flexibility in the system. In some embodiments, it is immaterial if the parent node has been moved to a different location in the hierarchical structure, thus giving it a new node number, since nodes are recognized by their system numbers rather than by their node numbers.

Checking for Structural Data Overflow

Structure Table Size. In one embodiment, if there is a limit on the number of nodes that can exist in any one Structure Table, then importing a subfile could result in this limit being exceeded. If this occurs, the import process cannot proceed and must be terminated 1508.

Sibling Groups. In one embodiment, if there is a limit on the number of nodes that can exist as a sibling group, then importing a subfile could result in this limit being exceeded. A sibling group is defined as a group of nodes that differ only in the last digits of their node numbers, such as 2.1, 2.2 and 2.3. Since the imposition of a sibling group size limit will prevent sibling overflow within any one file, overflow can only occur if nodes have been added to the target file independently of the source file, so that while neither source nor target files breach the limit, their combination will. If this occurs, the import process cannot proceed and must be terminated 1508.

Checking for Acceptability of Common Data Changes

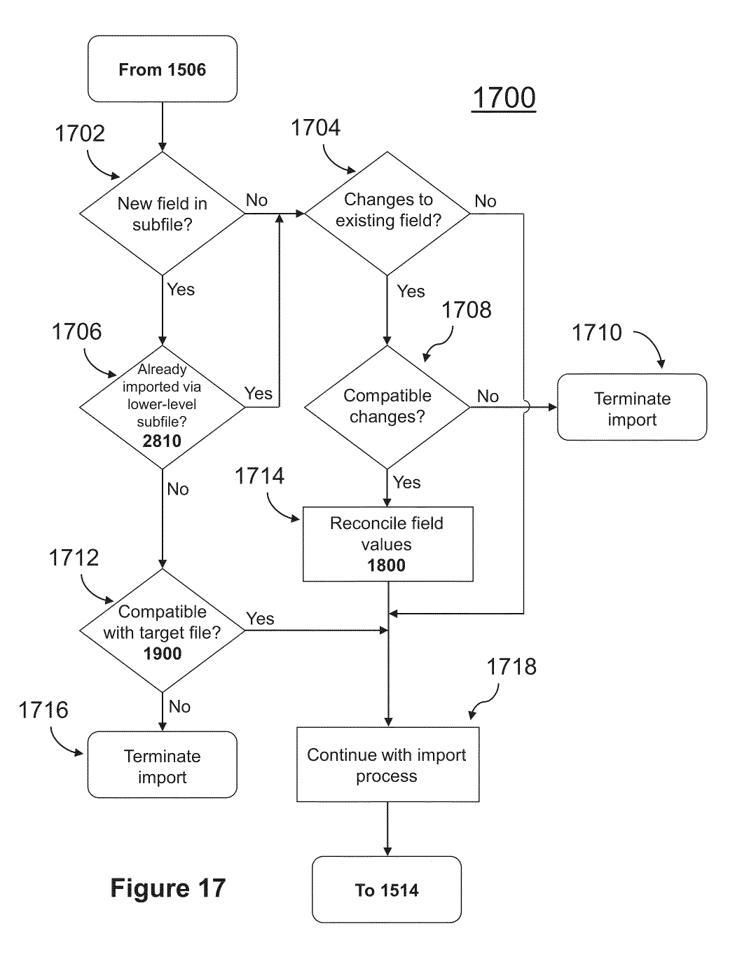

In one embodiment, subfile owners are permitted to add common data fields, and to modify common data fields inherited from the parent file. When the subfile is imported back into its parent or ancestor, any changes and additions may be reconciled 1700 with the set of common data fields in the target file as shown in FIG. 17. However, if the new or modified data is incompatible with the target file, the import process is terminated 1512. In one embodiment, the reconciliation process is completed before any data is imported so that, if termination occurs, the target file will not have been altered in any way.

Common data in the source file may include both fields which were originally inherited from the parent file, and new fields created in the source file since it was last imported 1702. Inherited data in the source file may have remained identical to its counterpart in the target file, in which case there is no need to import it, or changes may have been made to that data in either the source or the target or both 1704. If the work product module 334 determines that the changes are compatible 1708, i.e. are capable of being reconciled, then a user or operator is prompted to reconcile the two sets of data 1714. New data fields may be imported provided they are compatible with the target file 1712.

If incompatible changes have been made to an existing data field, as discussed above under Restrictions on Changing Common Data, the import process will be terminated 1710. If a new data field is incompatible with the target file, as discussed below under Compatibility of New Common Data Fields with Target File, the import process will also be terminated 1716.

As discussed below under Prior Importation of Common Data Fields, it is possible for an apparently new common data field in the source file to have already been imported into the target file from a lower-level subfile. In some embodiments, a check is made for this during the data reconciliation process 1706.

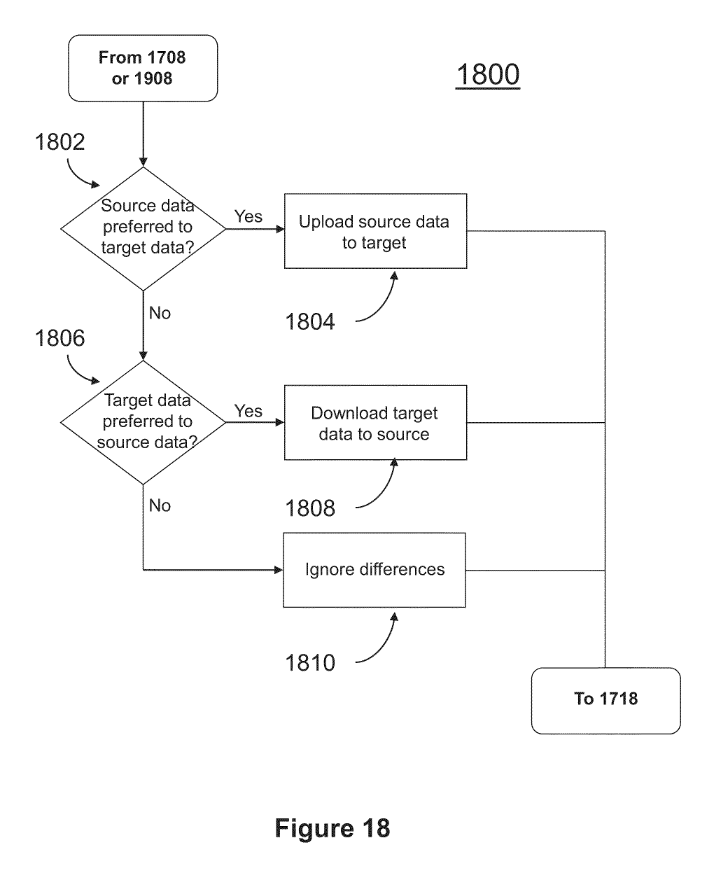

Reconciling Inherited Common Data Changes (FIG. 18)

As described above, if the work product module 334 determines that the changes to a common data field made in a subfile or in its parent/ancestor, or in both, will not cause irreconcilable differences, both source and target values are displayed for resolution by the operator. If the operator indicates that the source file value is preferred 1802 it will be uploaded 1804 to the target file. If the operator indicates that the target file value is preferred 1806 it will be downloaded 1808 to the source file. In some embodiments, the operator may indicate that the difference can be ignored 1810, for example, if it is not considered significant to the final outcome.

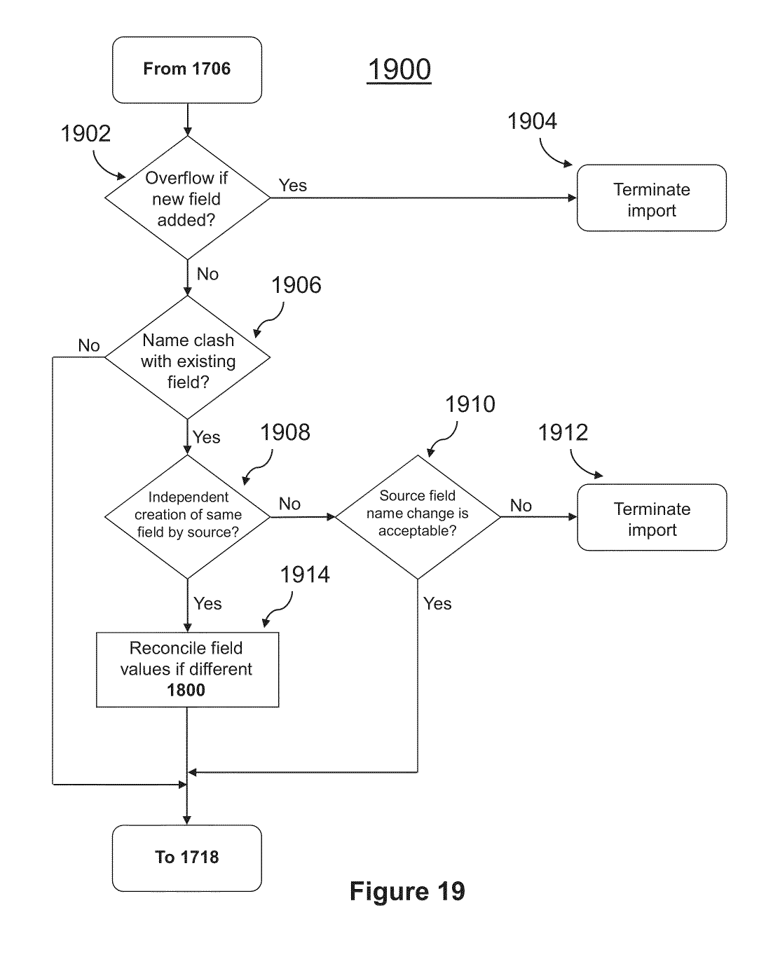

Compatibility of New Common Data Fields with Target File (FIG. 19)

If a new common data field is to be imported from a source file into a target file, two potential problems may arise.

i) If there is a finite storage capacity for that type of field, the new field may cause this capacity to be exceeded, resulting in overflow in the target file 1902. Detection of such a problem will result in termination of the import process 1904. It may not be possible to prevent all such overflow situations occurring where there are multiple, independent subfiles, so in one embodiment finding solutions to these situations is a responsibility of the target file owner.

ii) If the work product module 334 detects that a new field has been given the same name as that of an existing field in the target file 1906, the operator is alerted during the import process. In this scenario, two possibilities may arise. Firstly, the operator is prompted to indicate whether the new field represents the same physical quantity as the similarly-named target file field 1908. In this case, there is no need to import the new field unless it has a different value from its counterpart in the parent file, in which case it will be treated as if it were inherited data 1914—see Reconciling Inherited Common Data Changes, above. Alternatively, the operator is prompted to indicate whether the new field may represent a different physical quantity, and if so, the operator is prompted to assign the field a new name 1910. If renaming is not acceptable in such cases, the import process will be terminated 1912.

Updating System Number Maps Prior to Import

In one embodiment, system number maps are configured to record the correspondence between nodes in the source file and their counterparts in the target file. Such correspondences will reflect the state of affairs at the time the map was created, i.e. immediately after the subfile was exported, or immediately after an import process took place. However, in between export and first import, or in between subsequent imports, changes can occur to the structure of both source and target. The changes that can occur include node additions, deletions, and movements to/from/within the structure of both source and target. In some embodiments, these are corrected for in the system number map before import can commence, as described below.

Additions to Source File

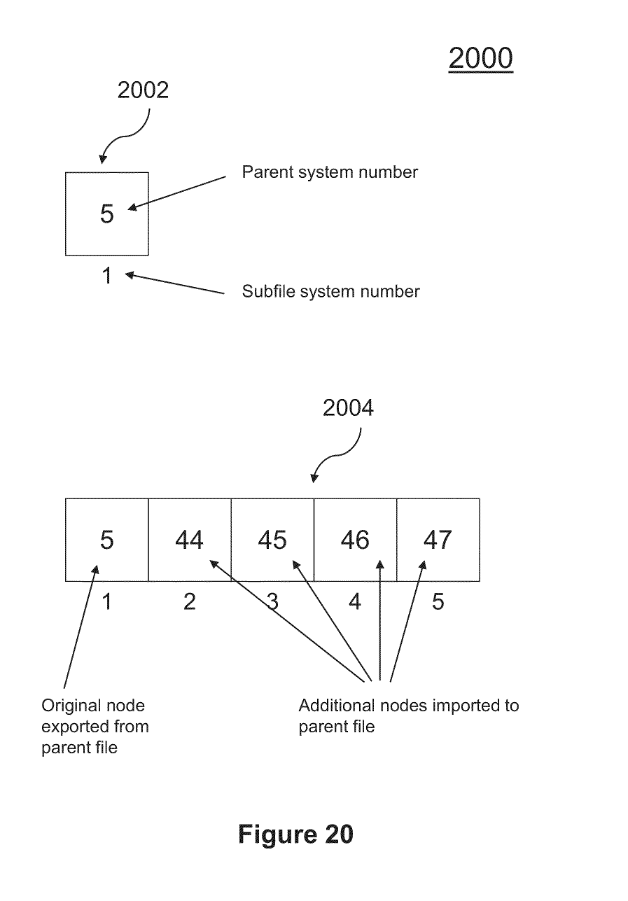

Any new nodes added to the source file will not be referenced in the system number map, and will therefore be imported into the target file as new nodes. They will automatically be assigned new system numbers in the target file as part of the import process. This is illustrated in FIG. 20, in which a subfile was originally exported from a node with system number 5 in the parent file. This node is assigned system number 1 in the subfile original system number map 2002. Four new nodes are then created in the subfile, with local system numbers 2 through 5. On import back into the parent file, they will be assigned the first four available system numbers in the parent file, in this case 44 through 47 as shown in the updated system number map 2004.

Deletions from Source File (Orphaned Nodes)

Any nodes deleted from the source file will obviously not be uploaded to the target at the next import. However, if a deleted node had been uploaded on a previous import, it will become an orphaned node in the target file, since it no longer has a counterpart in the source file. When an orphaned node is detected, a message is displayed to the operator to this effect, and the operator may then opt to delete this node in the target file as well.

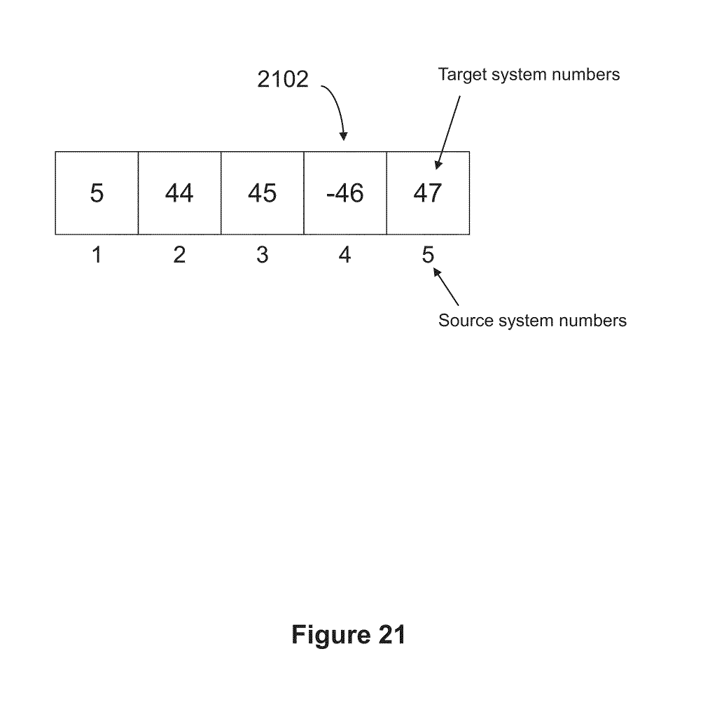

In one embodiment, orphaned nodes are detected by the work product module 334 comparing the system number map with the current list of nodes in the source file during the import process, and are distinguished in the corrected system number map by replacing the target system number in the map with its negative, as shown in FIG. 21. The node with system number 4 in the source file had previously been imported to the parent file in which it was assigned system number 46. Subsequently, node 4 was deleted in the source file, so on the next import this node is shown in the system number map with a negative value, i.e. −46 as shown in the system number map 2102.

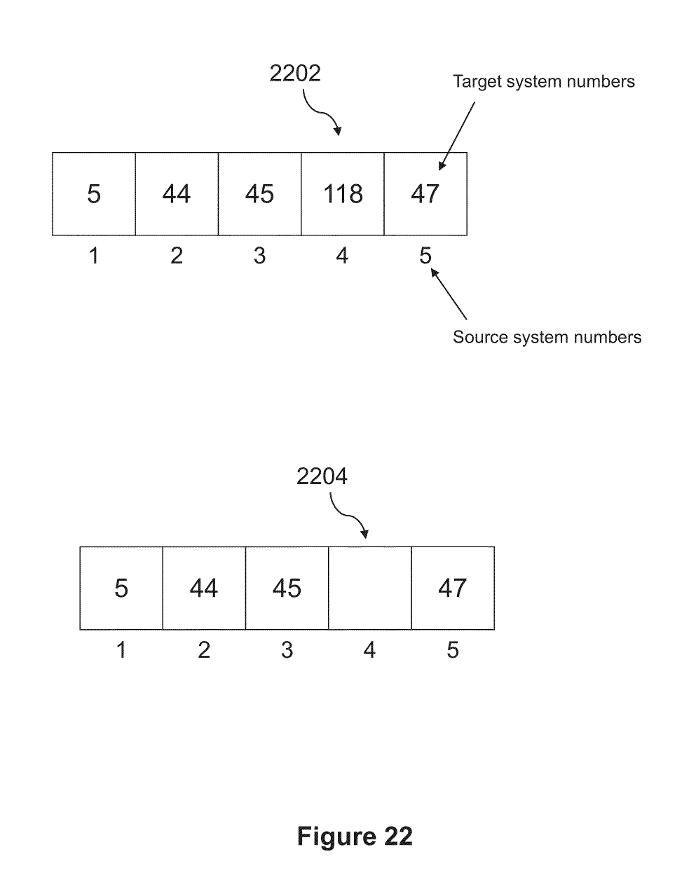

If the work product module 334 detects a node which was created in a subfile and then deleted before the next import so that it was never uploaded, it will be represented by an empty value in the system number map, to distinguish it from the case of deletion of a node which had already been uploaded. The work product module 334 is configured to apply the same treatment to a node which had been deleted previously and has already been dealt with. An example of a system number map 2204 showing this is given is FIG. 22.

Movements within Source File

Each node record within the Structure Table carries within it the details of its place in the structure, i.e. the system number of its parent and the system numbers of its children, if any. Provided that each node record imported from the source overwrites its earlier version in the target, the details of its current position in the structure will be imported, so that movements of nodes within the source will be faithfully copied to the target.

The movement of a node within the source file structure cannot move it outside the family of the parent node in the target, since subfiles are prohibited from adding nodes which are not descendants of the parent node (see Fleshing Out/Adding Descendant Nodes, above).

Additions to Target File

In some embodiments, the only additions of concern are additions of nodes within the family of the parent node in the target file, made independently of the source file. These will be integrated by the work product module 334 into the nodes uploaded from the source file. In one embodiment, the work product module 334 is configured to perform integration so that the independently added nodes in the target file will have the same node numbers before and after integration. Such additions can occur either by direct input to the target file, or by prior importation from a lower-level subfile (see Prior Importation of Nodes, below).

If there is a limit on the number of nodes that can exist as a sibling group, the independent creation of target nodes can lead to this limit being exceeded when the source data is imported into the target. Detection of sibling overflow will result in the import process being aborted, as discussed above under Checking for Structural Data Overflow.

Deletions from Target File

If a node has been deleted from the target file but still exists in the source file, it will simply be reinstated in the target file at the next import by the work product module with a different system number as illustrated in FIG. 22. The node with system number 4 in the source file had previously been imported to the parent file in which it was assigned system number 46 as shown in the system number map of FIG. 20. Node 46 was subsequently deleted in the target file, but because its counterpart in the source file, node 4, still exists, it will be reinstated at the next import, although with a new system number, in this example as system number 118 as shown in the system number map 2202. In some embodiments, system numbers, once discarded, are never reused by the work product module. This ensures that the system numbers of records in the Structure Table are always in increasing order, thereby permitting a more efficient method of locating any particular record rather than if the system numbers were in random order.

If a node has been deleted in both the source file and the target file, the corresponding entry in the system number map will be empty as shown in the example system number map 2204.

Movements within Target File

Movement of a subfile's parent node within the parent file will result in a different top-level node number for the subfile. This new top-level number will be downloaded by the work product module 334 to the subfile at the next import, where it will be used to update the node numbers of every node in the subfile.

Operator-initiated movements of nodes within the subfile family in the target file will be pointless unless no further importations of that subfile are expected, since the structure contained within the subfile node records will simply be re-imposed when the subfile is next imported.

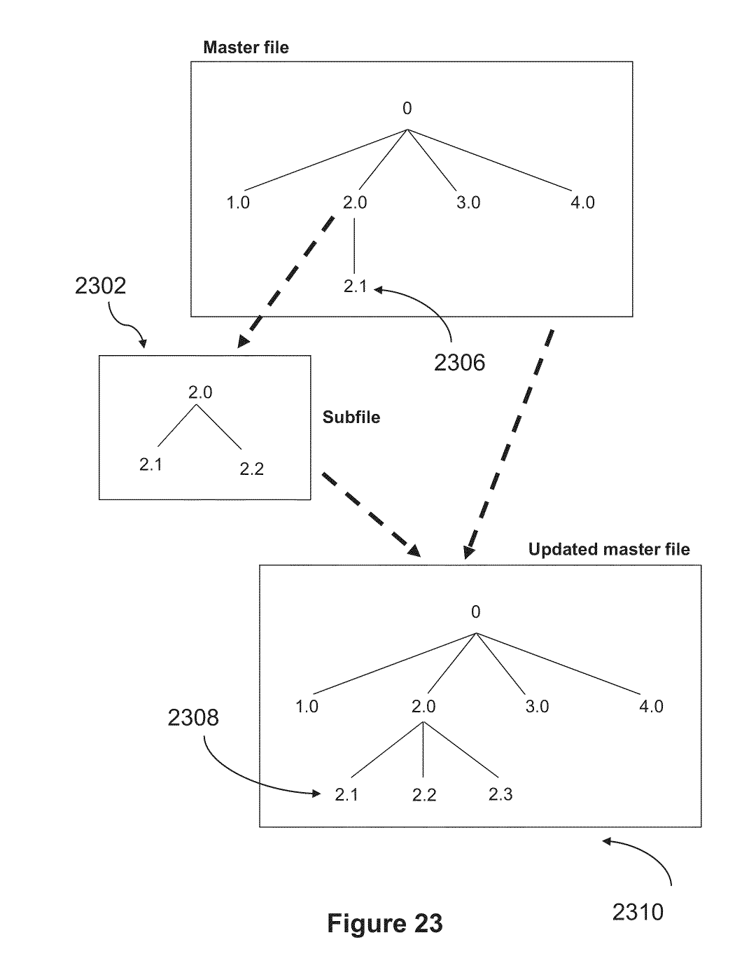

Automatic movements of nodes can occur when a new node is independently created within a subfile's family in the target file (see Additions to Target File, above), because when the subfile is subsequently imported the imported nodes will be made to ‘flow around’ the new node so as to preserve its node number. This is illustrated in FIG. 23, where a subfile 2302 has been formed from the 2.0 node of the master file, and descendant nodes 2.1 and 2.2 have been added in the subfile. Meanwhile, a 2.1 node has been independently added 2306 in the master file. When the subfile is imported back into the master file, the independently added 2.1 node in the master file keeps its node number 2308, so the added nodes in the subfile (2.1 and 2.2) become nodes 2.2 and 2.3 respectively in the updated master file 2310.

In some embodiments, movement of a node in the target file out of its subfile family can only be permanently effected if the corresponding node in the subfile is simultaneously deleted. For example, if it is decided that a node which has already been imported from a subfile belongs in another area altogether, it can be moved in the target file to that area, but would be automatically moved back again at the next import of its subfile. In order to prevent this, in some embodiments the work product module 334 is configured to alert an operator in response to a request to move or delete a node in a target file so that a request can be sent to the subfile owner to delete that node.

In some embodiments, the work product module 334 is configured to block a node from being imported from its original subfile in any subsequent import process if the node has been moved out of that subfile family within the parent file.

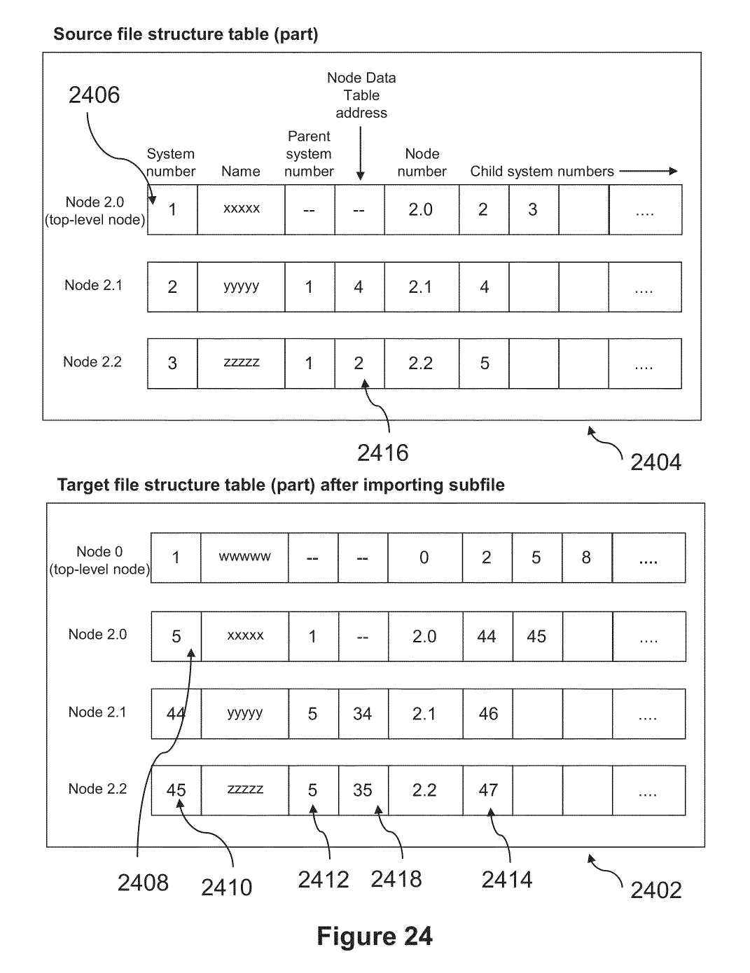

Importing Node Structural Records (FIG. 24)

A search is made in the target Structure Table 2402 by the work product module 334 for counterparts for each node record in the source Structure Table 2404, based on the system number map (FIG. 20) in the subfile LUT. Each source file node record will be overwritten onto its target file counterpart if the latter exists, or will be added as a new record to the target Structure Table if it does not exist.

If a counterpart to a source node exists in the target file, its system number and parent link in the target file are retained. Thus, for example, the top-level node in the source file has a system number 2406 of 1, which is changed to system number 5, on import into the target file 2408, and all its children will adopt this new parent system number 2412. All links to each node's children will be re-written in terms of their, possibly newly assigned, child system numbers 2414 in the target file. All Node Data Table addresses 2416 in the source file may be translated to new values 2418 in the target file.

In one embodiment, structural records in source and target are not associated on the basis of their node numbers, because it is possible for nodes in the target file to have been moved within the hierarchical structure since the source was exported or last imported, so that their node numbers will be different from those in the source file.

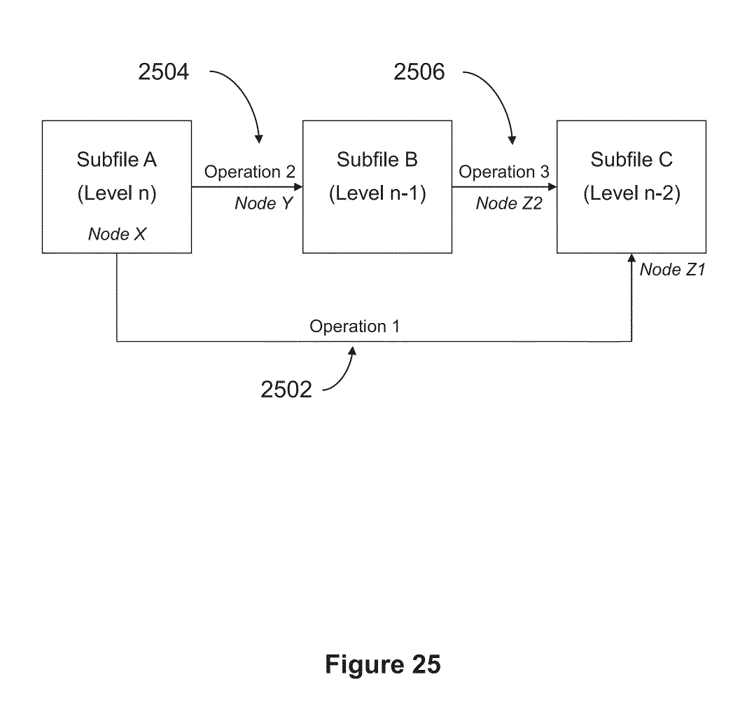

Prior Importation of Nodes. In a multi-level system it is possible for a node to be imported into a parent file by more than one route, as shown, for example, in FIG. 25. A node having system number X in the low-level subfile A at level n is imported directly into file C (which can be the master file or a higher-level ancestral subfile at level n−2) via a multi-level import 2502, where it is assigned system number Z1. The same node then may be imported at a later date from subfile A into subfile B 2504 at level n−1, where it is assigned system number Y, and from there imported into file C 2506, where it is assigned system number Z2, since there is no clear connection at this point with its earlier import as system number Z1.

In order to determine that Z1 and Z2 are the same, a check is made when subfile B is imported into subfile C of the multi-level A-to-C subfile LUT that will have been created when A was imported into C, and which maps file A system numbers to file C system numbers. When any import operation takes place, a search may be made in the target file for any subfile LUTs containing precursor system number maps of the form M-to-T where T is the target file and M is of the same subfile family but at a lower level than that of the source file. In this case, the A-to-C data map would be identified as a precursor, and all new node system numbers in file B (i.e. not referenced in the existing B-to-C system number map) may be checked to see if they originated in file A. If a node is found to have originated in file A and is referenced in the A-to-C data map, the established target system number in this map will be used for that node in the B-to-C import process rather than assigning it a new system number.

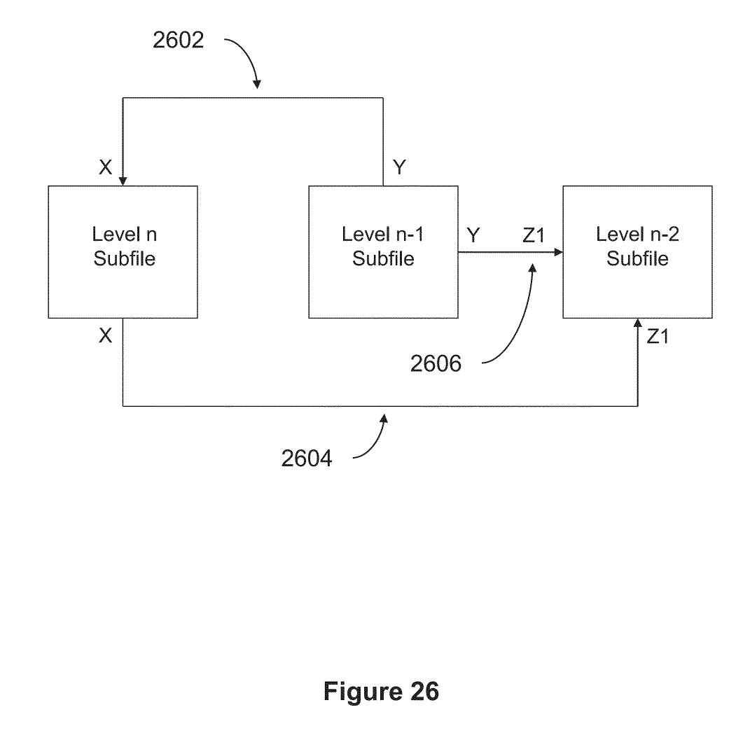

This process is shown diagrammatically in FIG. 26. Node Y in a subfile at level n−1 is determined to have originated as node X in its descendant subfile at level n, 2602. Node X has previously been mapped to Z1 in its level n−2 ancestor 2604, hence Y will also be mapped to Z1 in level n−2, 2606.

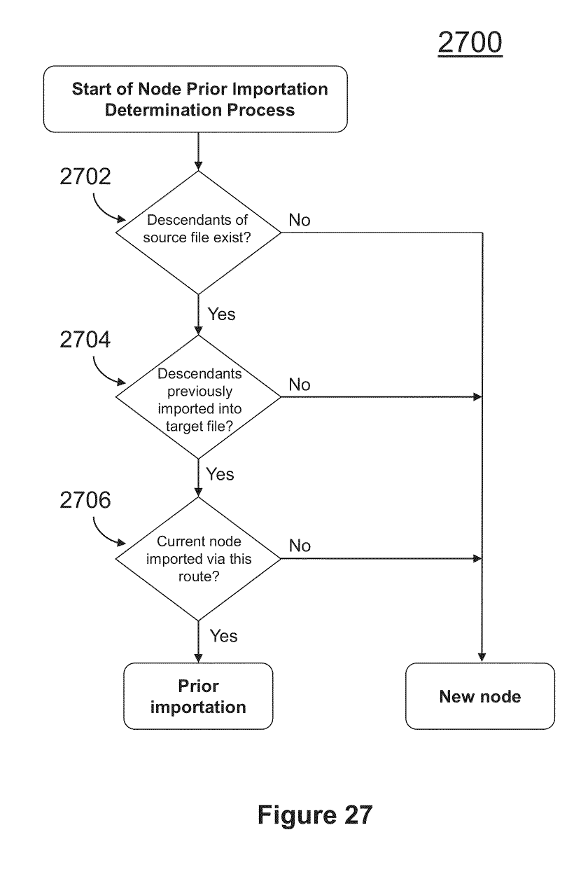

A flowchart for checking for prior importation is shown in FIG. 27. A check is made in any importation process to determine whether any descendants of the source file exist 2702, and if so, whether any of these have previously been directly imported into the target file 2704. If so, a further check is made to determine whether the current node is referenced in the subfile LUT for any of these importations, and has therefore already been imported into the target file 2706. If so, the current node will be treated as an existing node rather than a new node.

Importing Common Data

When common data is imported 1518, provided that common data reconciliation has been successfully completed, any new common data items will be added to the common data in the target file, and any updated field values for existing data items will also be entered into the target file, by the work product module 334 as described above. Any new common data items created in the source file are assigned field numbers in the target file and a record is made of these field numbers in the subfile LUT common data maps. In some cases, a problem may occur in a multi-level system, because it is possible in such cases for a new field to reach a target file by more than one route, in a similar process to that described above for node record importation under Prior Importation of Nodes.

Prior Importation of Common Data Fields

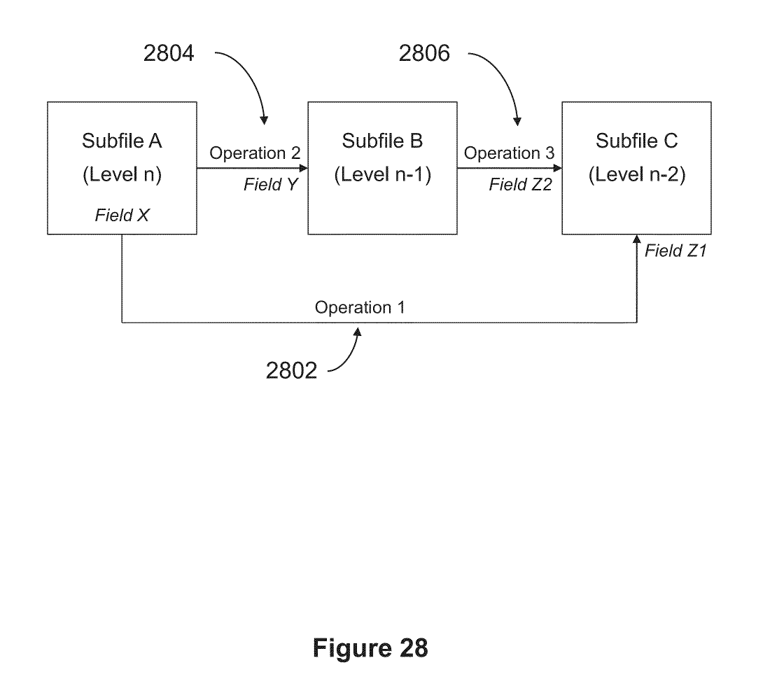

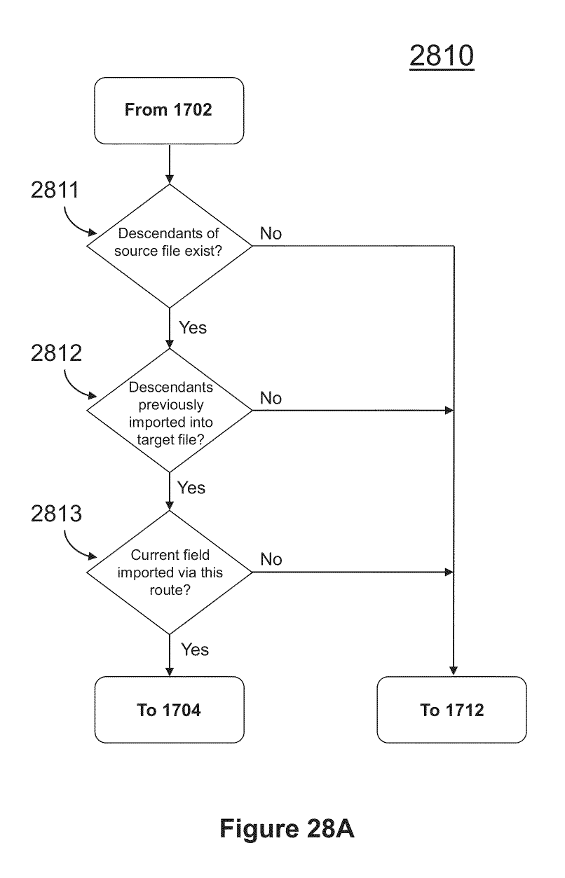

In a multi-level system, it is possible for a field to be imported into a parent file by more than one route, as shown for example in FIG. 28. Field X in the low-level subfile A is imported directly into file C (which can be the master file or a higher-level subfile) via a multi-level import 2802, where field X is designated field Z1. Field X then may be imported 2804 at a later date into subfile B, where it is designated field Y, and then imported 2806 into subfile C, where field X is given another designation as field Z2, since there is no clear connection during this action with the earlier import of field X as field Z1.

The occurrence of prior importation of common data fields is conceptually similar to that of prior importation of nodes, and in some embodiments, is dealt with by the work product module 334 in a similar fashion. A flowchart for checking for prior importation of common data fields is shown in FIG. 28A, which is similar in its operational concept to the flowchart for checking for prior importation of nodes shown in FIG. 27. As illustrated in FIG. 28A, the work product module 334 performs a check to determine whether descendants of the source file exist 2811. If so, a check is performed to determine whether any of these have previously been directly imported into the target file 2812. If so, a further check is performed to determine whether the current field existed at the time of importation and therefore would have been imported into the target file 2813. If so, the work product module 334 determines that the field was already imported via the lower level subfile and continues to determine whether changes have been made to the existing field (as shown in FIG. 17). If the current field has not been imported previously, further actions are taken as illustrated in FIG. 17.

Updating Subfile LUTs

The processes described above may result in a new system number map and one or more new common data maps, which will be incorporated by the work product module 334 into the subfile LUT for that import transition. The new LUT will replace the existing LUT in both source and target. If a LUT does not exist for this transition, i.e. if it is a multi-level transition which has not occurred before, a new LUT will be created by the work product module 334 and will be stored on both the source and target files.

In some embodiments, all LUTs for all transitions in the source file will be examined by the work product module 334, and if they do not occur in the target file they will be copied to the target file. If they occur in the target file but have an earlier date than the version in the source file, the target file version will be replaced by the source file version.

Importing Node-Specific Data

Node-specific data in any file resides in the Node Data Table for that file. Node Data Table records in the source file which have counterparts in the target file will overwrite their counterparts, provided the source data is of a later date than the corresponding target data. Node Data Table records in the source file which do not have counterparts in the target file will be written as new records to the target Node Data Table. All Node Data Table addresses 2416 in the node structural records written to the parent file Structure Table will be changed from their source file values to the new target file values 2418.

Fatal Errors

Detection of a fatal error by the work product module 334 will cause the import process to be terminated prior to any changes being made to the target file. In some embodiments, the following occurrences will be recognized by the work product module 334 as constituting fatal errors.

1. The source file is not a bona fide subfile of the target. This can occur if: a) the source file is not recognized as a subfile, i.e. is a master file or a completely unrelated file, or b) the source file does not have the same master file recognition code as the target file, or c) the source file is not a descendant of the target.

2. The subfile LUT or LUT chain leading from the source to the target cannot be found. This will usually be because an attempt is being made by a user to import a low-level descendant of the target into the target before all the intermediate single-level imports have occurred. It could also occur if data corruption has wiped out the LUTs on both the source and the target files.

3. The parent node in the target file has been deleted since the source file was created or last imported.

4. Adding the source data to the target would result in overflow in the target, either in the total number of nodes, or within a node sibling group, or in the number of fields within any of the common data areas.

5. An incompatibility is detected between one or more common data fields in source and target. Such incompatibilities are specific to the particular embodiment of this invention. However, a typical example would be a labor rate which was given in terms of hours of labor in the target file but had been changed to days of labor in the source file.

In some embodiments, messages displaying the suspected fatal error are presented to a user on a display of the computer 302a, 302b during the import process if the import process is terminated.

Data Dissemination

Common data from a constellation of subfiles may be disseminated to individual subfiles by downloading the complete set of common data from the target file to each source file as it is imported.

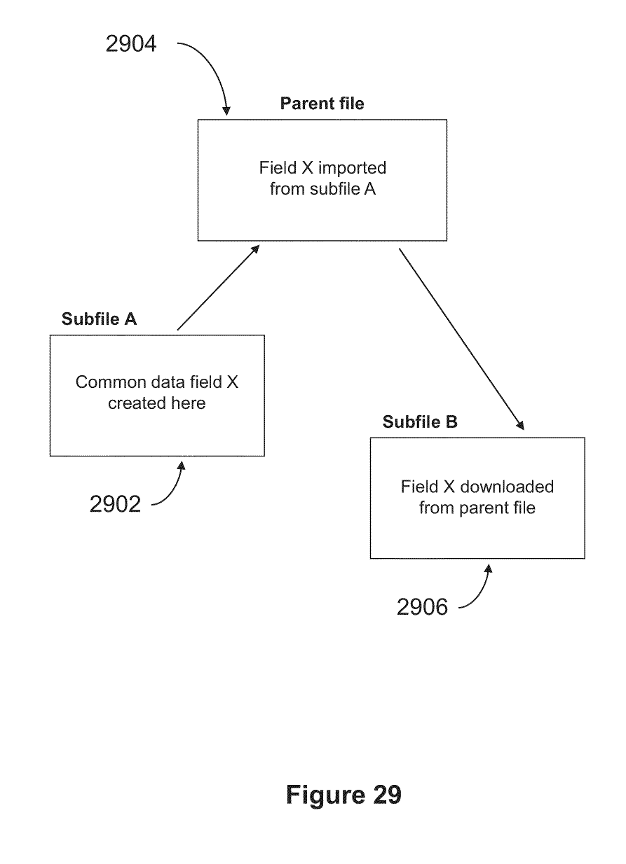

An example embodiment is illustrated in FIG. 29. If a new common data field originates in subfile A 2902 and is subsequently imported into its parent file 2904, then whenever any further subfiles are either created or are returned for import, field X may be downloaded to them. Common data is therefore disseminated in this way from subfile A to subfile B 2906, even though these two files may not be in contact with one another.

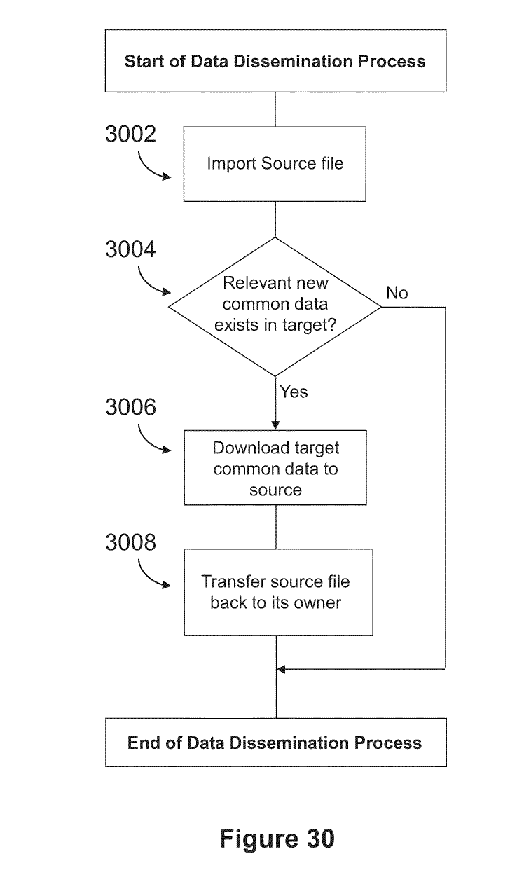

An example data dissemination process is illustrated in flowchart form in FIG. 30. The import process 3002 will result in a parent file accumulating all the common data originating in all of its descendant subfiles. A check is made 3004 to determine whether a subfile being imported contains the complete set of common data in the target file. If it does not, any missing data may be downloaded 3006 to that subfile after its importation is complete. In some embodiments a list of the missing data fields is displayed to the operator, who may then elect to download any, all or none of these fields. That subfile will then contain not only its own common data but may also contain some or all the common data originating in some or all of the other subfiles. Common data can therefore be disseminated across a constellation of subfiles by a process which in one embodiment, may be described as discrete diffusion, in the sense that updates take place as and when subfiles are returned to their parents or ancestors for importation. One part of this process is that subfiles updated in this way are then returned 3008 to their owners.

Any common data field types that were removed in their entirety from the subfile when it was originally created may be signified by empty data maps in the subfile LUT and will not be made available for download from the target file. Any individual common data fields that were removed from a particular field type in the subfile when it was originally created may be signified by negative field numbers in the corresponding data maps in the subfile LUT, and will not be made available for download from the target file.

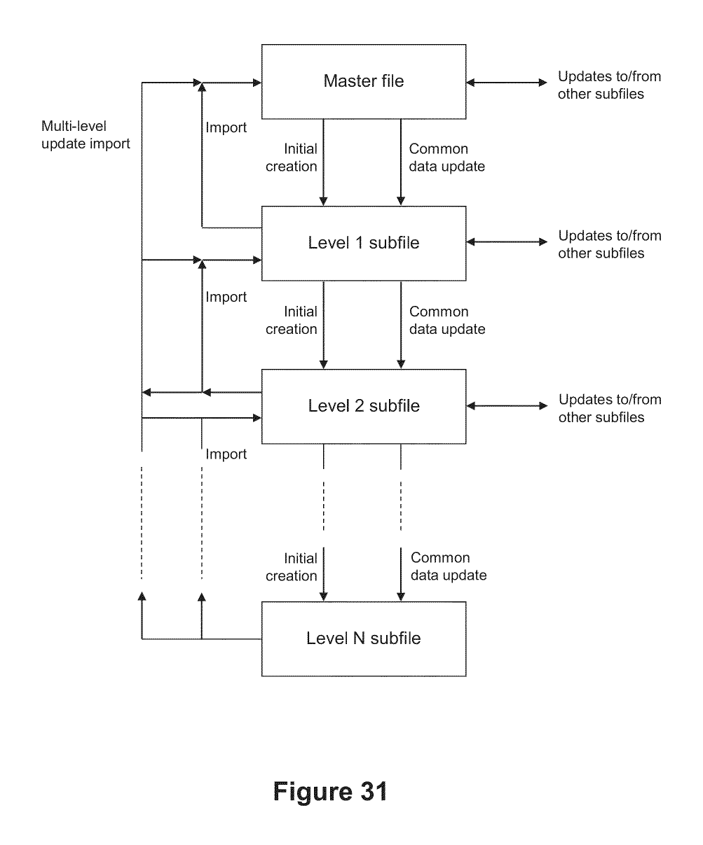

A diagram illustrating the sequence of data flows over several subfile levels is shown in FIG. 31.

Subfile Updating

At the end of the importation process the operator will be informed by the work product module 334 if any changes have been made to the source file, either by an update of the subfile LUT, or by a download of a new top-level node number or a changed value for a common data item, or by dissemination of common data. In one embodiment, if any changes have been made, it will be the operator's responsibility to transfer the updated source file back to its owner, by any means as described above.

If the updated source file is not transferred back to its owner, or if it is returned but its owner neglects to replace the original file with the updated file, no lasting harm will have been done, but the data renewal processes described above will simply reoccur if the source file is imported again for update purposes.

If the subfile LUT was updated in the import process, but the new version is not written onto the original subfile for either of the reasons mentioned above, problems can arise during subsequent importations because nodes or fields which had already been imported will not be recognized as having been imported. For this reason, in some embodiments, a copy of the LUT is maintained on both the parent file and the subfile, and the latest version of the two is always used to control the import process.

### Example Embodiment

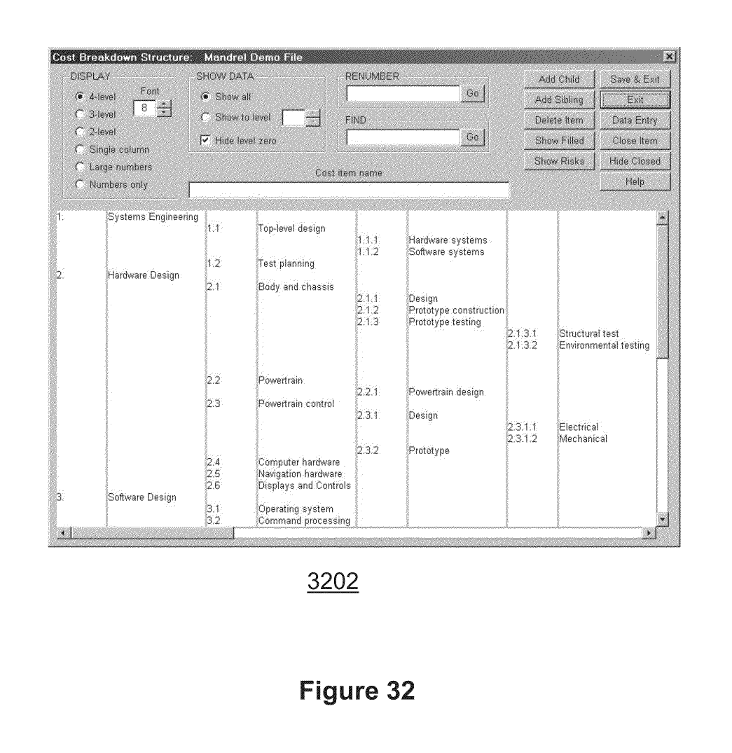

An example embodiment of a work product 340 and work product module 334 according to the methods and systems disclosed herein is illustrated in FIGS. 32 to 41 and described below.

The example embodiment consists of a project costing application in which uncertainty and risk are built in to all relevant data and calculations. Data is arranged in terms of a hierarchical cost breakdown structure (CBS). Individual nodes in the structure represent tasks or otherwise identifiable items of expenditure or revenue. The example embodiment is implemented in at least one computer 302a, 302b as described herein having a work product module 334 to enable the addition, deletion and moving of nodes in the structure, the adding and modifying of node-specific data to each node, and the defining and editing of common data.

The example embodiment uses the six processes described above (master file creation, exporting, fleshing out, importing, data dissemination, and subfile updating). The implementation of these processes follows the description given above, and the information given below merely adds additional detail for this specific embodiment.

Data Structure

In one embodiment, the data within any one file, whether master file or subfile, may be broken down into six major categories: 1. Structural data, 2. Node-specific data, 3. Common data, 4. System parameters, and 5. Subfile lookup tables (Subfile LUTs) as described above as well as 6. Report configurations category.

Structural Data

The example embodiment uses the Structure Table and node record system described previously. In one embodiment each node record also contains several additional parameters which provide control and information functions. These additional parameters include i) through iv) below.

i) Subfile flag, which is set if the node is the parent node of a subfile. If an attempt is made to delete this node, a warning is issued to the operator that doing so will make the associated subfile unreachable.

ii) Risk flag, which is set if the node has been assigned a probability of less than 1. This is used to provide a visual indication to the operator of the nodes which have been defined to be risks.

iii) Cost Polarity flag, which is set if the node represents a revenue, reset if the node represents an expenditure.

iv) Closure flag, which is set if the activity or expenditure represented by the node is deemed to be complete. In one embodiment changes or additions to node-specific data are inhibited for nodes which have their closure flags set.

In one embodiment, structural data is shown to the operator via a node definition and selection form 3202, an example of which is shown in FIG. 32. This form permits the operator to add, delete and move nodes, and to select nodes for data entry, report generation, and subfile creation.

Node-Specific Data

In one embodiment, each node in the hierarchical structure represents a cost item, which is defined as a task or equivalent line item of expenditure or revenue in the CBS. Each such item may be divided into a number of cost elements, where a cost element represents the smallest unit of expenditure or revenue that can be independently described. Examples of cost elements might be a number of labor hours or a subcontract. A typical breakdown of a cost item into its constituent cost elements is shown below.

Cost Item: Testing of new product

Cost Elements: (1). 100 hours of engineering labor; (2). 200 hours of technician labor; (3). Test equipment purchases; and (4). Rental of test facilities.

Each cost element can be in any currency and have any set of taxes applied to it, independently of all other cost elements.

Node-Specific Data Components. Data associated with a node can contain other data besides purely cost-related data. The various types of node-specific data in this embodiment are listed as (i) through (x).

(i) Direct cost amounts, i.e. cost elements defined in terms of a specified monetary amount, such as $10,000. Cost variance, currency and tax applicability are coded into this data. (ii) Defined cost amounts, i.e. costs defined in terms of a number of non-monetary units, such as 100 hours of labor. Cost variance and tax applicability are coded into the data, while currency is coded into the associated unit price (see Common Data, below). (iii) Identification field entries (see Common Data, below). (iv) List of applicable taxes. (v) Probabilities. (vi) Risk assessments. (vii) Descriptive text. (viii) Actions. (ix) Audit trail data. (x) System/housekeeping data.

Risks. Individual cost items can be regarded as planned expenditures or activities, or they can be regarded as provisional, or possible, expenditures or activities. The latter are called risks, i.e. expenditures that may have to be made or activities that may have to be undertaken, but not necessarily. Any cost item may be made provisional by assigning it a probability of less than 100%. Scope uncertainty can be included in a project or program by the use of such provisional cost items. If a cost item is defined as a risk, it can have non-cost risk impacts attached to it, such as schedule or safety.

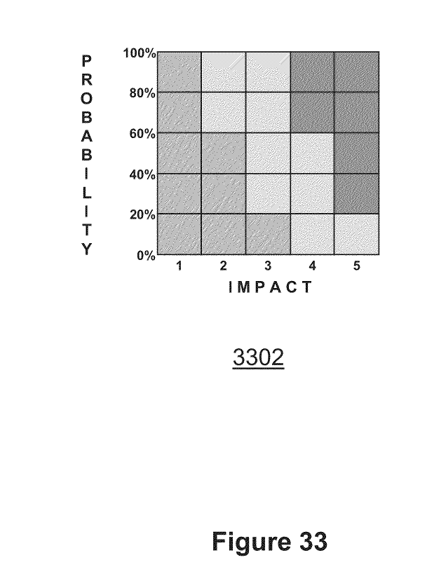

Risks can be displayed within the example embodiment in terms of a risk matrix 3302, an example of which is shown in FIG. 33. In one embodiment, the risk matrix size (number of elements along each axis) and its division into different zones are operator-definable.

Risk Impact Scales. Assessment of the impact of a risk is accomplished by comparing the estimated effect of the risk, should it occur, with one or more impact scales. The latter are operator-definable. The number of levels in each impact scale is defined by the risk matrix size. For this reason the matrix size may not be changed if any impact scales exist.

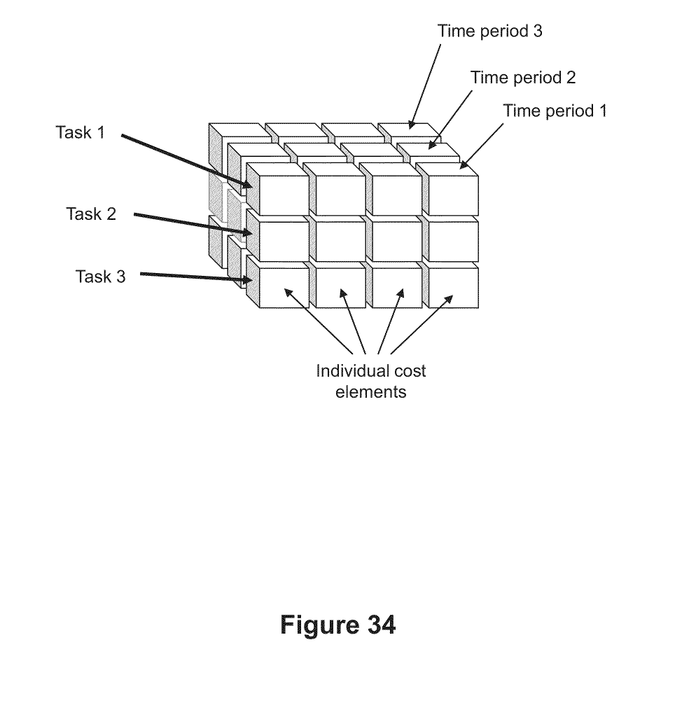

Cost Allocation. Cost elements themselves can be further subdivided by a process known as cost allocation. For example, costs could be divided into successive years, such as 2013, 2014, 2015, so that individual costs can be allocated to the year in which they will occur. Alternatively, costs could be divided into different divisions within an organization, such as Engineering, Manufacturing, Marketing, etc., so that individual costs can be allocated to their budgetary source. In more general terms, cost allocation creates a series of allocation blocks into which individual cost elements can be subdivided. Cost allocation, in effect, converts the 2-dimensional cost item/cost element structure into a 3-dimensional structure, such as cost item/cost element/time. A cost allocation system which divides cost elements into three time periods is illustrated in FIG. 34.

If a cost allocation system is in force and a cost item has been defined as a risk, its attached probability can have a different value in each allocation block.

Common Data

In an example embodiment, common data, i.e. data which may be used in any node, includes the following:

(i) Price definitions, including both labor rates and materials prices; (ii) Tax definitions and tax rates; (iii) Currency definitions and exchange rates; (iv) Identification field definitions. Identification fields are operator-definable fields which can be attached to cost items. A typical field would be Task Manager; (v) Risk impact definitions and impact scales; (vi) Actionee name list; (vii) Cost allocation parameters; (viii) Risk matrix parameters.

Report Configurations

Reports within the example embodiment are operator-configurable. Thus, for example, a cost register report, which is a tabular report employing rows and columns of data in a spreadsheet-like format, can be configured to have any desired set of fields, can include any set of cost items displayed in any definable order, with operator-definable formatting.

A report configuration is a specification for a report. The example embodiment provides storage for several thousand such configurations.

Operator Controls

The example embodiment contains all the necessary controls for adding and modifying structural data, node-specific data, common data and report configurations in master files and subfiles, together with special-purpose controls for manipulating subfiles. A person skilled in the art will be familiar with controls for a user to add and modify data.

In one embodiment, the work product module 334 provides a number of user commands or controls including subfile manipulation controls as described below:

| COMMAND | RESULT |
|---|---|
| Create | Permits the operator to choose a node in the currently open |
| Subfile | file and create a new subfile from it. See Exporting |
| | Subfiles, below. |
| Import | Permits the operator to select a file and import it into the |
| Subfile | currently open file. See Importing Subfiles, below. |
| Show | Displays a list of the immediate subfiles of the currently |
| Subfiles | open file. |
| Delete | Permits the user to delete one or more subfiles of the |
| Subfiles | currently open file, by deleting all reference to it in the |
| | current file. |
| New Master | Converts the currently open file into a new master file and |
| File | stores the result under a new name. See Master File |
| | Establishment, below |

Export/Import Overview

FIGS. 35A-35D illustrate an overview of an export/import cycle within the context of the example embodiment. FIG. 35A shows the nodes comprising a master file in the early stages of development, as they would appear in the node definition and selection form in selection mode. Assuming that node 2.0 has been selected for export as a subfile, FIG. 35B shows the node composition of this subfile immediately after it has been created by the work product module 334. FIG. 35C then shows the node composition of this subfile after fleshing out, and finally FIG. 35D shows the node composition of the master file after the 2.0 subfile has been imported back into it. As described above, the system 300 enables a user to transfer the subfile containing node 2.0 to another computer 302a which may or may not be connected by a computer network to the computer 302b storing the master file. A user may work to flesh out the subfile which may then subsequently be imported back into the master file

Master File Establishment

A master file can be created ab initio, or it can be created from any existing master file or subfile.

Ab initio creation uses the New Datafile command of the example embodiment, and creates a minimal file with a zero-level node but no other data. In one embodiment, the master file recognition code is not created until the first subfile is about to be exported.

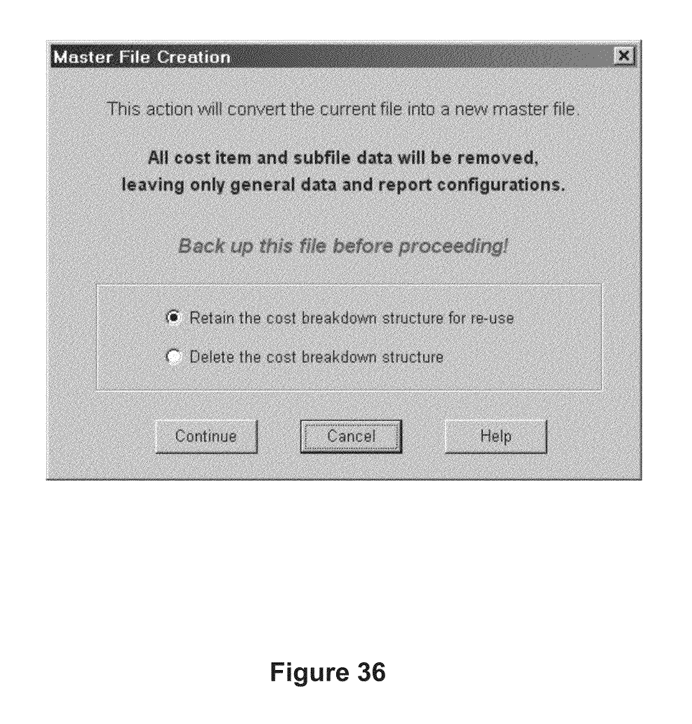

Creation from an existing file allows all the common data, the report configurations, and optionally the structural data in the old file to be retained for re-use in the new file. This method involves the deletion of all node-specific data and all subfile LUTs in the old file, resetting all subfile-related system parameters to their default values, and the deletion of the old master file recognition code. As for the ab initio case, the new master file recognition code is not created until the first subfile is about to be exported. FIG. 36 shows the form presented to the operator when this method of master file creation is selected.

If the structural data is deleted from the old file, all report configurations are examined and any that reference specific structural nodes are deleted, since these nodes may not necessarily exist in the new master file.

Exporting Subfiles

Operator Controls

The example embodiment contains a single menu-based command for subfile creation, labelled as Create Subfile. Selection of this menu command will cause the node selection form to appear, enabling the operator to choose the node which will become the top-level node of the new subfile. If this is an ancestor or descendant of an existing subfile, subfile creation will be disallowed, a notice to this effect will appear, and the process will be terminated, otherwise the new subfile will be created by the work product module 334 without further operator input.

Common Data Removal

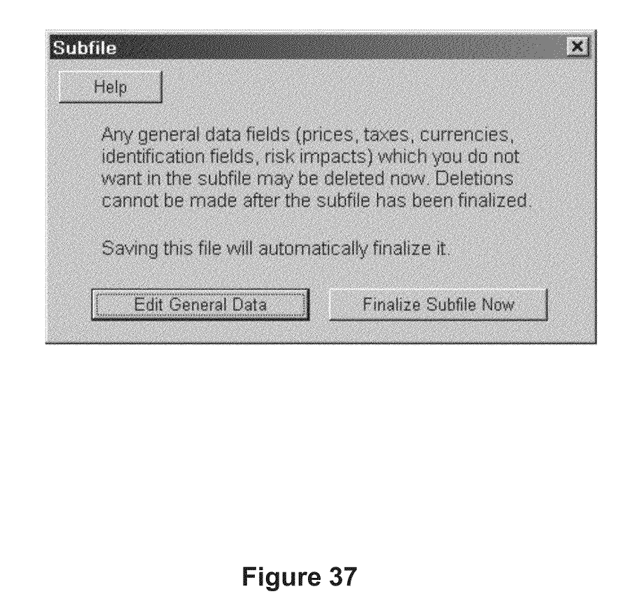

The final stage in the subfile creation process will be the appearance of a notice informing the operator that any unwanted common data can be removed at this stage (FIG. 37). In one embodiment, once the subfile creation process has been finalized (a Finalize button appears on the notice, and finalization will occur in any case as soon as the new subfile is saved), common data items inherited from the parent file cannot be deleted.

If an item of common data is selected for removal, a check will be made by the work product module 334 to ensure that the item is not referenced in any node-specific data in the subfile. If a reference to it is discovered, its removal will be disallowed. If not, it will be deleted and its field number will be included in the appropriate data map in the subfile LUT as a negative value to indicate that this item has been deleted.

Report Configuration Filtering

A subfile will inherit the complete set of report configurations in the parent file. It is possible for report configurations to refer to specific nodes or node families in the CBS. If a configuration refers to a node which does not exist in the subfile, such references must be removed when the subfile is created, otherwise an error would occur if that configuration were called to create a report. For example, if the subfile is headed by node 2.0 then all references in the configuration to nodes outside the 2.0 family, such as 3.0 or 4.0, must be removed.

Fleshing Out Subfiles

As described above, after a subfile has been created by the export process, nodes may be added, deleted or moved within the hierarchical structure within the subfile. Node specific data also may be added, modified or deleted in the subfile.

Common Data Changes

Common data also may be added to subfiles which may be referred to as potential common data since such data exists at this point only within a single file. Existing common data fields received from the parent file also may be modified.

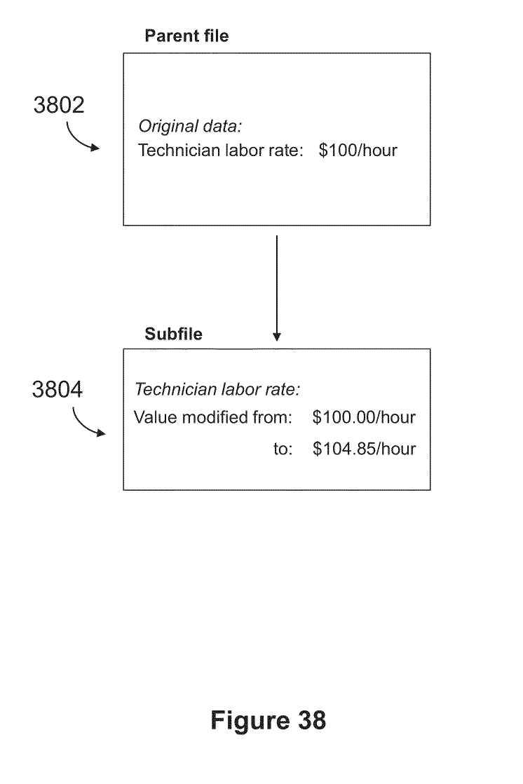

The latter is illustrated in FIG. 38, in which the master file originally contained a data item 3802 consisting of an hourly labor rate for a technician. If, for example, the value of this data item was not known at the time the master file was created, it may have been given a nominal figure of $100 per hour. This data item was inherited by the 2.0 subfile when the latter was created. If, for example, the owner of this subfile has better information about this labor rate, the hourly labor rate may be modified to create a modified data item 3804 having a value of $104.85 per hour.

Restrictions on Changing Common Data. In one embodiment, subfiles are prohibited from modifying common data inherited from their parent files in a manner that would cause irreconcilable differences between the subfile and its parent, such as changes that would cause the data in the subfile to be interpreted incorrectly when imported into the parent file. For example, if the technician labor rate were modified 3804 to be a daily rate rather than an hourly rate, and data were consequently entered into the subfile in terms of days of labor, this same data would be interpreted as hours of labor when subsequently imported back into the parent file since the corresponding rate in the parent file is still defined in terms of hours. For example, if the data in a subfile node were entered as 10 days of technician labor, this would be interpreted as 10 hours of technician labor when imported into the parent file. The parent file rate cannot be modified to be a daily rate by the import process since the parent file may have already imported data in terms of hours from other subfiles.

Changes to common data which might cause irreconcilable differences of this nature can only be made in the master file. If such changes are made, a warning notice is displayed.

Permissible Data Changes. Changes to prices, taxes, currencies, identification fields, risk impacts, and actionees are permitted in subfiles in some embodiments, subject to the restrictions outlined above. Changes to cost allocation and risk matrix parameters may be forbidden in subfiles since these changes will almost always lead to irreconcilable differences. Consequently, in one embodiment, the menu commands which give access to common data such as cost allocation and risk matrix parameters are disabled in subfiles.

Operator Controls

The example embodiment contains all the necessary controls for adding and modifying structural, node-specific, and common data in subfiles. The same controls are used in both master file and subfiles. A person skilled in the art will be familiar with the general nature of controls for adding and modifying data, which do not therefore need to be described here.

Importing Subfiles

Common Data Changes in Subfiles

A common data field value may be changed in a subfile or in its parent/ancestor, or in both. If this occurs, then both values are displayed during importation for resolution by the operator.

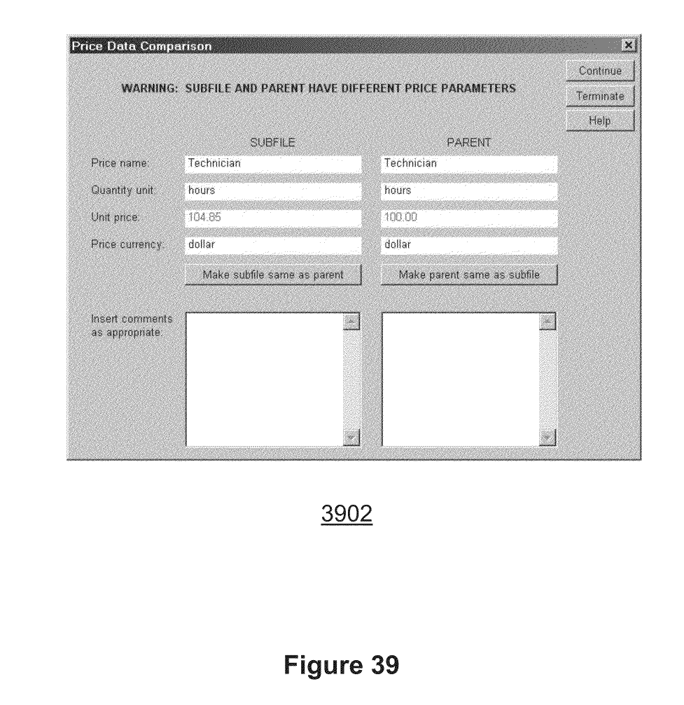

Continuing the example illustrated in FIG. 38, the technician labor rate has a value of $100/hr in the parent file and $104.85 in the subfile. When the subfile is imported back into the parent file, the two values are displayed to the operator during the import process, for example, in a message or window 3902 as shown in FIG. 39, so that a choice between them can be made. The operator may elect to upload the subfile value to the parent file, download the parent value to the subfile, or ignore the difference if it is not considered significant. Should the operator decide that further investigation is required before making a choice, an option exists to terminate the import process. If this option is selected, no changes will be made to either the subfile or the parent file, and the import process may be restarted at a future time.

Common Data Changes in the Master File

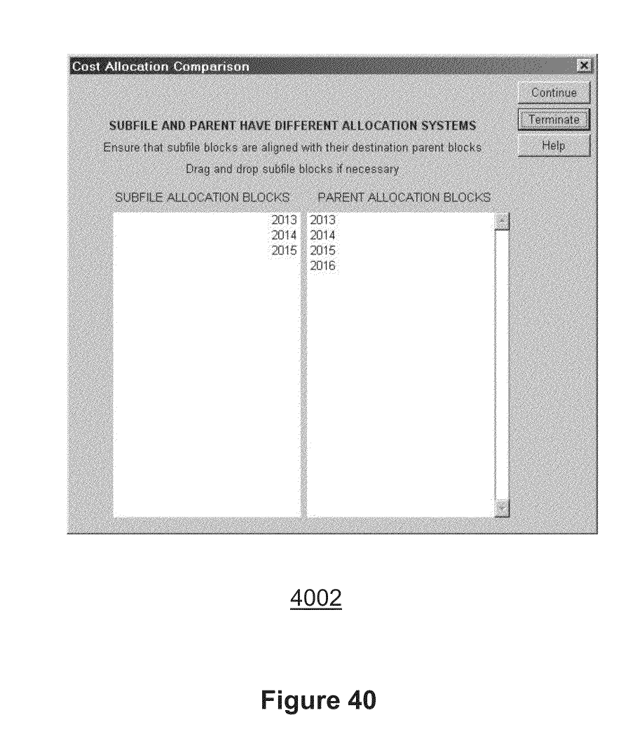

While certain common data changes are not permitted in subfiles, they may be made in the master file. For example, if a cost allocation system has been set up in the master file prior to exporting a subfile, and the names of the allocation blocks are subsequently changed or their number is increased, the new allocation system will be downloaded to the subfile by the work product module 334 during the import process. The operator is notified of the change that will occur to the subfile during import, for example, in a message or window 4002 as shown in FIG. 40. Since the new allocation system may constitute a different ordering of allocation blocks, the operator has the ability to specify which subfile blocks will correspond to which master file blocks.

If the number of allocation blocks in the master file had been decreased rather than increased, there would be orphaned allocation blocks in the subfile, i.e. allocation blocks for which no counterpart exists in the parent file. A fatal error would occur in such circumstances.

Fatal Errors

Detection of a fatal error will cause the import process to be terminated prior to any changes being made to the target file. The following fatal errors are recognized in the example embodiment:

1. The source file is not a bona fide subfile of the target. This can occur if: (a) the source file is not recognized as having been created by the same software, or (b) the source file is not a subfile, i.e. is a master file, or (c) the source does not have the same master file recognition code as the target file, or (d) the source file is not a descendant of the target.

2. The subfile LUT or LUT chain leading from the source to the target cannot be found. This will usually be because an attempt is being made by a user to import a low-level descendant of the target into the target before all the intermediate descendants have been imported. It could also occur if data corruption had wiped out the LUTs on both the source and the target files, although this is expected to be an unlikely occurrence.

3. The parent node in the target file has been deleted since the source file was created or last imported.

4. Adding the source data to the target would result in overflow in the target, either in the total number of cost items, or within a cost item sibling group, or in the number of fields within any of the common data areas (prices, taxes, currencies, identification fields, risk impacts).

5. An incompatibility is detected between one or more common data fields such as where source and target files have irreconcilably different risk matrix sizes. A difference can only arise if the master file is changed after the subfile is created, because, in the example embodiment, the ability to change the matrix configuration is denied to subfiles. If no risk impact scales have been set up in the source file, the new matrix configuration may be downloaded to it. However, if any impact scales have been created in the source file, a fatal error will occur because matrix size may not be changed in a file if any impact scales exist in that file.

6. An incompatibility is detected between one or more common data fields such as where the target file contains fewer cost allocation blocks than the source file, with the result that one or more of the source file blocks will be ‘orphaned’, i.e. there will be no place for them upon import into the parent file. This can only occur if the number of allocation blocks in the master file is decreased after the subfile is created, because, in the example embodiment, the ability to change the allocation system is denied to subfiles.

7. An incompatibility is detected between one or more common data fields such as where the source file has a calendar based cost allocation system and the target file has a non-calendar based system, or vice versa. Again, this can only occur if the master file is changed after the subfile is created, because, in the example embodiment, the ability to change the allocation system is denied to subfiles.

8. An incompatibility is detected between one or more common data fields such as where the source file and target file both have calendar based allocation systems, but the time period lengths are different, e.g. the source file uses years while the target file uses months. Again, this can only occur if the master file is changed after the subfile is created, because, in the example embodiment, the ability to change the allocation system is denied to subfiles.

9. An incompatibility is detected between one or more common data fields such as where a price definition common to both source and target has a different quantity unit and/or a different currency in the source and target files. This can only occur if the quantity unit and/or currency in the master file are changed after the subfile is created because, in the example embodiment, the ability to make such changes to inherited price definitions is denied to subfiles.

Operator Controls

The example embodiment contains a single menu-based command for subfile importation, labelled as Import Subfile. In response to a user selecting this menu command, an Open File form is generated, enabling the operator to select the source file which is to be imported. It is assumed that the target file into which it is to be imported is already open. If no file is currently open, the menu command will have been disabled. Once this has been done, the importation process will be conducted and completed by the work product module 334 unless and until one of the following occurs:

1. A fatal error is detected, as described above, in which case the importation process will be terminated without any changes having been made to either the source or the target file.

2. A non-fatal difference is detected in the values associated with one or more common data fields, in which case the different values will be displayed to the operator with a request to select one of them. If the source value is selected it will be uploaded to the target, if the target value is selected it will be downloaded to the source, or the operator may elect to ignore the difference if it is not considered significant. Having made an appropriate choice, the operator may then continue the import process.

3. The operator elects to terminate the import process while attempting to reconcile a non-fatal difference in a common data field. Typically this would be done in order to obtain more information about the difference.

Data Dissemination

Operator Controls

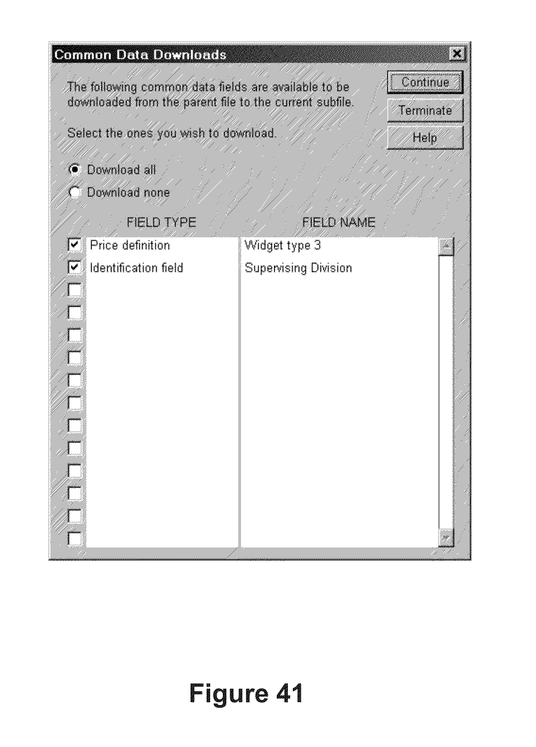

Dissemination of common data occurs as part of the importation process and in one embodiment, does not involve a separate menu command or user request. If any common data items are available for download from a target file to a source file, in one embodiment, a list of such common data items will be displayed to the operator during the importation process. An example of this is shown in FIG. 41. The operator may then make the decision to download any, all, or none of them to the source file. Data items that were removed from the subfile when it was first created will be excluded from this process; a record of removed data items is maintained in the appropriate data map for this purpose, as described above. Thus, while a subfile and any updates or additions contained therein are imported into a parent or ancestor file, the subfile may be updated at the same time to reflect any changes or additions to common data in the parent or ancestor file, which may have occurred as a result of the imports of other subfiles into the cost breakdown structure or by new fields introduced directly into the parent or ancestor file. Changes in data made in other subfiles by other users are thus propagated to the source file even where the computer storing the source file is not linked through a communications network with computers storing other subfiles of the same family.

Subfile Updating

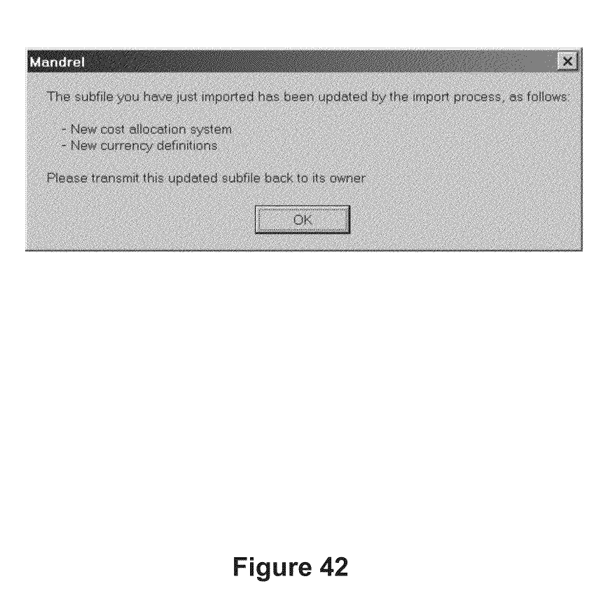

If any changes are made to the subfile during the importation process, the operator will be notified of this fact and requested to return the updated subfile to its owner. An example of this is shown in FIG. 42.

Should the subfile not be returned to its owner, or should the subfile owner neglect to replace the original subfile with the updated file, no lasting harm will be done, but the data renewal processes described above will simply reoccur if the source file is imported again for update purposes.

Although the exemplary embodiments described herein employ the memory 322, other types of computer readable media which can store data that are accessible by a computer or computer processor, such as magnetic cassettes, flash memory cards, digital versatile disks, cartridges, random access memories (RAMs), read only memory (ROM), a cable or wireless signal containing a bit stream and the like, also may be used in the exemplary operating environment. Non-transitory computer-readable storage media expressly exclude media such as energy, carrier signals, electromagnetic waves and signals per se.

While this invention has been described in conjunction with specific embodiments thereof, it is evident that the invention is not limited to these specific embodiments. Rather, numerous alternatives, modifications and variations will be apparent to those skilled in the art in light of the foregoing description, as well as the present specification as a whole including the claims. Accordingly, the purpose and intention of the inventors is to embrace and include all reasonably foreseeable alternatives, modifications and variations as fall within the broad scope of the invention as described and claimed herein.

1. A method of maintaining and updating a data structure in a computing device, the method comprising:
creating a master file containing a data structure table representing a hierarchical data structure consisting of one or more nodes, each node being related to at least one other node by a parent-child relationship, each node having a unique system number and a record in the data structure table, the record having fields containing the unique system numbers of the node, its parent, and any child nodes;
exporting any selected node from the master file, the selected node being exported from the master file by:
generating a subfile for the selected node and any lower level nodes descending from that node, each node being assigned a subfile system number, the subfile containing:
node-specific data,
a subfile structure table having a record for each node in the subfile, the record having fields for the subfile system numbers of the node, its parent node, and any child nodes, and
a subfile lookup table having a subfile system number map of subfile system numbers and corresponding unique system numbers in the master file; and
retaining a copy of the subfile lookup table in the master file; and
importing a modified subfile for the previously exported node into the master file by updating records in the data structure table based on the subfile system number map and corresponding records in the subfile structure table.

2. The method of claim 1 further comprising exporting any selected node from any subfile, that subfile becoming a parent subfile, the selected node being exported from the parent subfile by,
generating the subfile for the selected node and any lower level nodes descending from that node, each node being assigned a subfile system number, the new subfile containing:
node-specific data,
the subfile structure table having a subfile record for each node in the subfile, the record having fields for the subfile system numbers of the node, its parent node, and any child nodes, and
the subfile lookup table having a subfile system number map of subfile system numbers and corresponding subfile system numbers in the parent subfile; and
retaining a copy of the subfile lookup table in the parent subfile; and
importing a modified subfile for the previously exported node into the parent subfile by updating records in the parent subfile structure table based on the subfile system number map and corresponding records in the subfile structure table.

3. The method of claim 2 further comprising successively exporting nodes and generating up to N levels of subfiles from the master file, wherein importing a modified n^{th} level subfile comprises updating records in the (n−1)^{th} level parent subfile structure table based on the n^{th} level subfile system number map and corresponding records in the n^{th} level subfile structure table, wherein n is between 2 and N.

4. The method of claim 1 further comprising transferring the subfile for the exported node to a second computing device and receiving the modified subfile from the second computing device prior to importing.

5. The method of claim 4 wherein transferring the subfile for the exported node comprises sending the subfile for the exported node to the second computing device over a wired or wireless communications network or storing the subfile to a non-transitory computer readable media for use by the second computing device and wherein receiving the modified subfile from the second computing device comprises receiving the modified subfile from the second computing device through a wired or wireless communications network or retrieving the subfile from a non-transitory computer readable media.

6. The method of claim 2 wherein exporting any selected node from the master file or any subfile further comprises first determining whether a subfile has previously been generated for exporting a node from that master file or that subfile which is a parent, ancestor, child or descendant of the selected node in the hierarchical structure, and if not, exporting the selected node.

7. The method of claim 2 wherein importing the modified subfile into the master file or into its parent file includes:
assigning a unique system number in the master file, or assigning a new subfile system number in the parent subfile, to each new node added from the modified subfile,
updating the subfile lookup table to update the subfile system number map, and
storing the updated subfile lookup table in the subfile and the master file or parent file.

8. The method of claim 2 wherein the master file or parent subfile further comprises common data relevant to two or more nodes in the hierarchical data structure, each common data item being assigned a unique field number in the master file, and wherein exporting the selected node from the master file further comprises copying the common data from the master file to the subfile for the selected node, and wherein exporting the selected node from the parent subfile further comprises copying the common data from the parent subfile to the child subfile for the selected node.

9. The method of claim 8 wherein the subfile lookup table includes a common data map of subfile field numbers to corresponding unique field numbers in the master file or a common data map of subfile field numbers to corresponding subfile field numbers in the parent subfile.

10. The method of claim 9 wherein importing the modified subfile comprises first reconciling changes to common data pre-existing in both the subfile and the parent subfile or master file at the time of importation, and copying new common data items from the subfile into the parent subfile or master file.

11. The method of claim 8 further comprising, after importing the modified subfile, copying new common data from the master file or parent subfile to the imported subfile.

12. The method of claim 3 wherein importing a modified subfile comprises copying all subfile lookup tables for all previous levels of imports into the modified subfile to the parent subfile or master file.

13. The method of claim 12 further comprising importing a modified n^{th} level subfile directly into a (n−x)^{th} level ancestral subfile, the ancestral subfile being the master file or one of the parent subfiles in a chain of parent subfiles between the level n subfile and the master file, where x is greater than one, by:
generating a multi-level subfile lookup table for the import of the n^{th} level subfile to the (n−x)^{th} level subfile, including a multi-level subfile system number map based on the sequence of system number maps between the n^{th} level, (n−1)^{th} level and up to (n−x)^{th} level subfiles;
importing the modified n^{th} level subfile into the (n−x)^{th} level ancestral subfile by updating records in the (n−x)^{th} level ancestral subfile structure table based on the multi-level subfile system number map and corresponding records in the n^{th} level subfile structure table; and
storing the multi-level subfile lookup table in the n^{th} level subfile and in the (n−x)^{th} level ancestral subfile.

14. The method of claim 13 wherein importing a modified subfile into the master file or its parent file, the master file or parent file being the target file, further comprises:
determining whether any descendant subfiles at one or more levels below the modified subfile have been previously directly imported into the target file,
determining whether a new node in the modified subfile originated from a descendent n^{th} level subfile,
in response to the new node in the modified subfile originating from the descendent n^{th} level subfile, determining whether the new node is included in the subfile lookup table and the multi-level subfile system number map for the import of the n^{th} level subfile to the target file, and if so,
updating the subfile system number map of the modified subfile based on the multi-level subfile system number map from the subfile lookup table for the import of the n^{th} level subfile to the target file; and
updating records in the target subfile structure table based on the updated subfile system number map and corresponding records in the modified subfile structure table.

15. The method of claim 9 wherein importing a modified subfile into the master file or its parent file, the master file or parent file being the target file, further comprises:
determining whether any descendant subfiles at one or more levels below the modified subfile have been previously directly imported into the target file,
determining whether a new common data item in the modified subfile originated from a descendent n^{th} level subfile,
in response to the new common data item in the modified subfile originating from the descendent n^{th} level subfile, determining whether the new common data item is included in the subfile lookup table and a multi-level common data map for the import of the n^{th} level subfile to the target file, and if so,
updating the common data map of the modified subfile based on the multi-level common data map from the subfile lookup table from the subfile lookup table for the import of the n^{th} level subfile to the target file; and
updating common data in the target subfile based on the updated common data map and common data items in the modified subfile.

16. The method of claim 3 wherein each subfile lookup table includes information indicating a date of the latest amendment and wherein prior to importing the subfile, the method comprises comparing the date of the subfile lookup table in the n^{th} level subfile with the date of the subfile lookup table retained in the (n−1)^{th} level parent subfile and using the most recently updated subfile lookup table for importing the subfile.

17. A non-transitory computer readable storage medium having stored thereon computer-readable and computer-executable instructions, which, when executed by a processor, cause a computing device to perform actions comprising:
creating a master file containing a data structure table representing a hierarchical data structure consisting of one or more nodes, each node being related to at least one other node by a parent-child relationship, each node having a unique system number and a record in the data structure table, the record having fields containing the unique system numbers of the node, its parent, and any child nodes;
exporting any selected node from the master file, the selected node being exported from the master file by:
generating a subfile for the selected node and any lower level nodes descending from that node, each node being assigned a subfile system number, the subfile containing:
node-specific data,
a subfile structure table having a record for each node in the subfile, the record having fields for the subfile system numbers of the node, its parent node, and any child nodes, and
a subfile lookup table having a subfile system number map of subfile system numbers and corresponding unique system numbers in the master file; and
retaining a copy of the subfile lookup table in the master file; and
importing a modified subfile for the previously exported node into the master file by updating records in the data structure table based on the subfile system number map and corresponding records in the subfile structure table.

18. The non-transitory computer readable storage medium of claim 17 wherein the computer-executable instructions, when executed by the processor, further cause the computing device to perform actions comprising:
exporting any selected node from any subfile, that subfile becoming a parent subfile, the selected node being exported from the parent subfile by,
generating the subfile for the selected node and any lower level nodes descending from that node, each node being assigned a subfile system number, the new subfile containing:
node-specific data,
the subfile structure table having a subfile record for each node in the subfile, the record having fields for the subfile system numbers of the node, its parent node, and any child nodes, and
the subfile lookup table having a subfile system number map of subfile system numbers and corresponding subfile system numbers in the parent subfile; and
retaining a copy of the subfile lookup table in the parent subfile; and
importing a modified subfile for the previously exported node into the parent subfile by updating records in the parent subfile structure table based on the subfile system number map and corresponding records in the subfile structure table.

19. The non-transitory computer readable storage medium of claim 18 wherein the computer-executable instructions, when executed by the processor, further cause the computing device to perform actions comprising successively exporting nodes and generating up to N levels of subfiles from the master file, wherein importing a modified n^{th} level subfile comprises updating records in the (n−1)^{th} level parent subfile structure table based on the n^{th} level subfile system number map and corresponding records in the n^{th} level subfile structure table, wherein n is between 2 and N.

20. A computing device comprising:
a processor; and
one or more non-transitory computer readable media having computer executable instructions stored thereon for maintaining and updating a data structure, which, when executed by the processor, cause the computing device to perform actions comprising:
creating a master file containing a data structure table representing a hierarchical data structure consisting of one or more nodes, each node being related to at least one other node by a parent-child relationship, each node having a unique system number and a record in the data structure table, the record having fields containing the unique system numbers of the node, its parent, and any child nodes;
exporting any selected node from the master file, the selected node being exported from the master file by:
generating a subfile for the selected node and any lower level nodes descending from that node, each node being assigned a subfile system number, the subfile containing:
node-specific data,
a subfile structure table having a record for each node in the subfile, the record having fields for the subfile system numbers of the node, its parent node, and any child nodes, and
a subfile lookup table having a subfile system number map of subfile system numbers and corresponding unique system numbers in the master file; and
retaining a copy of the subfile lookup table in the master file; and
importing a modified subfile for the previously exported node into the master file by updating records in the data structure table based on the subfile system number map and corresponding records in the subfile structure table.

21. The computing device of claim 20 further comprising a communications interface and wherein the computing device is configured to send the subfile for the exported node to a second computing device over a wired or wireless network through the communications interface and to receive the modified subfile from the second computing device from the wired or wireless network through the communications interface.

22. The computing device of claim 21 wherein the computer-executable instructions, when executed by the processor, further cause the computing device to perform actions comprising:
exporting any selected node from any subfile, that subfile becoming a parent subfile, the selected node being exported from the parent subfile by,
generating the subfile for the selected node and any lower level nodes descending from that node, each node being assigned a subfile system number, the new subfile containing:
node-specific data,
the subfile structure table having a subfile record for each node in the subfile, the record having fields for the subfile system numbers of the node, its parent node, and any child nodes, and
the subfile lookup table having a subfile system number map of subfile system numbers and corresponding subfile system numbers in the parent subfile; and
retaining a copy of the subfile lookup table in the parent subfile;
importing a modified subfile for the previously exported node into the parent subfile by updating records in the parent subfile structure table based on the subfile system number map and corresponding records in the subfile structure table; and
successively exporting nodes and generating up to N levels of subfiles from the master file, wherein importing a modified n^{th} level subfile comprises updating records in the (n−1)^{th} level parent subfile structure table based on the n^{th} level subfile system number map and corresponding records in the n^{th} level subfile structure table, wherein n is between 2 and N.
